(19) United States
(12) Patent Application Publication
(10) Pub. No.: US 2026/0299584 A1
(43) Pub. Date: Oct. 1, 2026

(54) METHOD FOR SUPPORTING REMOTE CALLING OR AUTONOMOUS PARKING

(71) Applicant: CHAMSULE TECH CO., LTD., Seoul (KR)

(72) Inventor: Jungtae Han, Incheon (KR)

(21) Appl. No.: 19/678,824

(22) Filed: May 15, 2026

Related U.S. Application Data
(63) Continuation of application No. PCT/KR2025/021740, filed on Dec. 15, 2025.

(30) Foreign Application Priority Data
Mar. 25, 2025 (KR) 10-2025-0140358
Mar. 25, 2025 (KR) 10-2025-0140367
Mar. 25, 2025 (KR) 10-2025-0140370
Oct. 2, 2025 (KR) 10-2025-0145433
Oct. 2, 2025 (KR) 10-2025-0145436

(51) Int. Cl. G05D 1/227; B60W 30/06; G08G 1/16; H04W 4/40

(52) U.S. Cl. CPC G05D 1/2278; B60W 30/06; G08G 1/168; H04W 4/40

(57) ABSTRACT

A method for supporting remote calling may include receiving GPS location information provided from GPS satellites in a normal mode, when the GPS location information is not received or when a reception sensitivity of the GPS location information is weaker than a preset reference sensitivity, receiving input information including geographic information and detecting whether a first event occurs, and generating transform GPS location information to be used as substitute information for the GPS location information based on the input information obtained when an occurrence of the first event is detected; and when the occurrence of the first event is detected. The method may further include transitioning from the normal mode to a first operation mode for supporting the remote calling of an autonomous driving vehicle and allowing the transform GPS location information to be provided to the autonomous driving vehicle as destination location information for the remote calling.

### CROSS REFERENCE TO RELATED APPLICATIONS

This is a continuation application of International Patent Application No. PCT/KR2025/021740 filed on Dec. 15, 2025, which claims priority to Korean patent application Nos. 10-2025-0140358, 10-2025-0140367, and 10-2025-0140370 filed on Mar. 25, 2025, and Korean Patent Application Nos. 10-2025-0145433 and 10-2025-0145436 filed on Oct. 2, 2025, contents of each of which are incorporated herein by reference in their entireties.

### BACKGROUND

### Technical Field

The present disclosure relates to a method capable of smoothly supporting remote calling or autonomous parking in a parking lot.

### Description of Related Technology

As automobile steering control technology rapidly develops, not only electric vehicles equipped with batteries but also vehicles driven by various driving energy sources are capable of having autonomous driving functions.

### SUMMARY

One aspect is for smoothly supporting remote calling for autonomous driving vehicles in an area where GPS location information is not received from satellites or where reception sensitivity of GPS location information is weak.

Another aspect is for smoothly supporting autonomous parking for autonomous driving vehicles in an area where GPS location information is not received from satellites or where reception sensitivity of GPS location information is weak.

However, the aspects are not limited to those described herein.

According to an aspect of the present disclosure, a method for supporting remote calling to be performed by a mobile device includes receiving GPS location information provided from GPS satellites in a normal mode in which the GPS location information is being received; when the GPS location information is not received or when a reception sensitivity of the GPS location information is weaker than a preset reference sensitivity such that location information different from the GPS location information is required, receiving input information including geographic information and detecting whether a first event occurs; generating transform GPS (TGPS) location information to be used as substitute information for the GPS location information based on the input information obtained when an occurrence of the first event is detected; and when the occurrence of the first event is detected, transitioning from the normal mode to a first operation mode for supporting the remote calling of an autonomous driving vehicle and allowing the transform GPS location information to be provided to the autonomous driving vehicle as destination location information for the remote calling.

The first event may occur in response to at least one of: when a wireless signal is received from at least one wireless signal generator installed in a reception shadow area in which it is difficult to normally receive the GPS location information; when code information is obtained from at least one QR code installed in the reception shadow area; when a user of the mobile device directly inputs the destination location information for the remote calling in the reception shadow area or selects the destination location information from a coordinate table of a parking lot through a screen of the mobile device; when mapped destination location information corresponding to fingerprint recognition or facial recognition of the user is received from a home network server communicating with a common entrance lobby phone installed in the reception shadow area, in a case where the user performs the fingerprint recognition or the facial recognition at the common entrance lobby phone; when, in response to a parking location confirmation request, mapped location information corresponding to a camera installed near a parking location of the autonomous driving vehicle and performing vehicle number recognition is received from a parking location and guidance server configured to perform the vehicle number recognition through cameras in the reception shadow area and to control parking location and parking guidance; when mapped location information corresponding to the camera installed near a parking location of the autonomous driving vehicle and performing vehicle number recognition is received from the parking location and guidance server, which responds to vehicle information obtained by capturing the autonomous driving vehicle in a parked state; when, while the vehicle information is obtained by capturing the autonomous driving vehicle in the parked state, the wireless signal is received from the wireless signal generator; and when mapped location information corresponding to code information obtained by capturing the QR code installed near the parking location of the autonomous driving vehicle is received.

The method may further include controlling an operation mode of the mobile device to return from the first operation mode to the normal mode when a release event of the first event occurs.

The release event may occur in response to at least one of: when a wireless signal generated from a wireless signal generator participating in occurrence of the first event is not received or has a signal strength weaker than a preset sensitivity; when the mobile device is paired with a Bluetooth device installed in the autonomous driving vehicle; when a beacon signal is received from a mode-release BLE beacon additionally installed in the autonomous driving vehicle; when a preset time related to the first event elapses; when, in a case where the autonomous driving vehicle exits from an underground parking lot to an outside, a beacon signal is received from a GPS return beacon installed at an exit of the underground parking lot; when a user of the mobile device directly provides a release input of the first event through the mobile device; and when parking location information is not confirmed or exit information recognized through a camera is received from a parking location and guidance server configured to perform vehicle number recognition through cameras in the underground parking lot and to control parking location and parking guidance.

In the first operation mode, the method may further include: receiving, from the input information obtained when occurrence of the first event is detected, floor-level information of a parking lot in which the mobile device is located; when communication with a parking location and guidance server is possible, receiving, within the same parking lot, floor-level information in which the autonomous driving vehicle is parked; when the floor-level information of the mobile device matches the floor-level information of the autonomous driving vehicle and is within a preset distance, notifying a user of the mobile device that the remote calling is available; when the floor-level information of the mobile device differs from the floor-level information of the autonomous driving vehicle, notifying the user that the autonomous driving vehicle is located on a different floor; when the floor-level information of the autonomous driving vehicle is not received, notifying the user that the autonomous driving vehicle may exist on either the same floor or a different floor; and controlling the transform GPS location information to be provided as the destination location information for the remote calling.

The wireless signal generator may include at least one of a BLE beacon, a Wi-Fi device, and a UWB transmitter; and installation location information of the BLE beacon, the Wi-Fi device, or the UWB transmitter and installation location information of the QR code may be mapped, in a coordinate form including latitude and longitude, into an information storage server wirelessly communicating with a communication module of the mobile device.

The information storage server may be a cloud server; and when coordinate requests for installation locations of the BLE beacon, the Wi-Fi device, the UWB transmitter, the common entrance lobby phone, or the QR code are received from a plurality of mobile devices within a preset time, the information storage server may perform waiting notification and sequential processing to relieve congestion of autonomous driving vehicles to be remotely called.

In the controlling, an autonomous driving vehicle control application interoperating with a full self-driving application of the autonomous driving vehicle may be used.

According to another aspect of the present disclosure, a non-transitory computer-readable storage medium storing computer-executable instructions, the computer executable instructions, when executed by a processor, cause the processor to perform a method, the method including: receiving GPS location information provided from GPS satellites in a normal mode in which the GPS location information is being received; when the GPS location information is not received or when a reception sensitivity of the GPS location information is weaker than a preset reference sensitivity such that location information different from the GPS location information is required, receiving input information including geographic information and detecting whether a first event occurs; generating transform GPS (TGPS) location information to be used as substitute information for the GPS location information based on the input information obtained when an occurrence of the first event is detected; and when the occurrence of the first event is detected, transitioning from the normal mode to a first operation mode for supporting the remote calling of an autonomous driving vehicle and allowing the transform GPS location information to be provided to the autonomous driving vehicle as destination location information for the remote calling.

According to still another aspect of the present disclosure, a method for supporting autonomous parking to be performed by a mobile device includes receiving GPS location information provided from GPS satellites in a normal mode in which the GPS location information is being received, detecting whether a second event occurs by receiving input information including geographic information when the GPS location information is not received or when reception sensitivity of the GPS location information is weaker than a predetermined reference sensitivity such that location information different from the GPS location information is required, generating transform GPS location information to be used as substitute information for the GPS location information based on the input information received with reference to empty parking space information when an occurrence of the second event is detected, and transitioning from the normal mode to a second operation mode for supporting the autonomous parking of an autonomous driving vehicle when the occurrence of the second event is detected and allowing the transform GPS location information to be provided to the autonomous driving vehicle as destination location information for the autonomous parking.

The second event may occur in response to at least one of situations including when a wireless signal for performing the autonomous parking is received from at least one wireless signal generator installed in a reception shadow area in which it is difficult to normally receive the GPS location information, when code information for performing the autonomous parking is obtained from at least one QR code installed in the reception shadow area, when a user of the mobile device directly inputs the destination location information for the autonomous parking or selects the destination location information from a parking-lot coordinate table for performing the autonomous parking through a screen of the mobile device, when an entry signal for the second event mapped in correspondence to fingerprint recognition or facial recognition of the user is received from a home network server communicating with a common entrance lobby phone installed in the reception shadow area in a case where the user of the mobile device performs the fingerprint recognition or the facial recognition through the common entrance lobby phone, and when the user of the mobile device directly provides a setting input for the second event through the mobile device.

When a release event of the second event occurs, an operation mode of the mobile device may be controlled to return from the second operation mode to the normal mode. In this case, the release event may occur in response to at least one of situations including when the autonomous driving vehicle reaches a destination of the autonomous parking, when the user of the mobile device directly provides a release input for the second event through the mobile device, and when parking location information related to the autonomous driving vehicle is received from a parking location and guidance server that performs vehicle number recognition through cameras and controls parking location and parking guidance in an underground parking lot.

A movement distance of the autonomous parking may be set to be within a preset distance.

In the second operation mode, when the occurrence of the second event is detected, whether a user input of the mobile device is received may be determined, when the user input is received, parking availability status for parking zones of the autonomous driving vehicle requested by the user may be requested, when an available parking zone exists, the transform GPS location information corresponding to a selected parking space in the available parking zone may be received and generated, when the user input is not received, empty parking space information within a parking zone including a preferred parking zone of the user may be received, and the transform GPS location information corresponding to the empty parking space selected by the user among the empty parking spaces may be received and generated, when a battery state of the autonomous driving vehicle is abnormal, the transform GPS location information of a fire safety zone stored in advance may be obtained and generated, and the generated transform GPS location information may be provided as parking space information corresponding to the destination location information of the autonomous parking.

The wireless signal generator may include at least one of a BLE beacon, a Wi-Fi device, and a UWB transmitter. In this case, the destination location information may include floor-level information of a parking lot and may be mapped, in a coordinate form including latitude and longitude, in an information storage server wirelessly communicating with a communication module of the mobile device.

The information storage server may be a cloud server. When coordinate requests for the destination location information are received from a plurality of mobile devices within a preset time, the information storage server may perform waiting notification and sequential processing to relieve congestion of autonomous driving vehicles to be autonomously parked.

In the allowing of the transform GPS location information to be provided, an autonomous driving vehicle control application interoperating with a full self-driving application of the autonomous driving vehicle may be used.

According to still another aspect of the present disclosure, a mobile device includes a GPS reception module that receives GPS location information in a normal mode; an event detection module that detects whether a first event occurs when location information different from the GPS location information is required; a transform GPS generation module that generates transform GPS location information based on input information obtained when an occurrence of the first event is detected; and a control module that, when the occurrence of the first event is detected, transitions from the normal mode to a first operation mode for supporting remote calling of an autonomous driving vehicle and allows the transform GPS location information generated by the transform GPS generation module to be used as destination location information for the remote calling.

According to still another aspect of the present disclosure, a mobile device includes an event detection module that detects whether a second event occurs when location information different from GPS location information is required, a transform GPS generation module that generates transform GPS location information based on input information received with reference to empty parking space information when an occurrence of the second event is detected, and a control module that transitions from a normal mode to a second operation mode for supporting autonomous parking of an autonomous driving vehicle when the occurrence of the second event is detected and allows the transform GPS location information generated by the transform GPS generation module to be used as destination location information for the autonomous parking.

According to still another aspect of the present disclosure, a location transform system for supporting remote calling or autonomous parking of an autonomous driving vehicle includes a location information provider that provides destination location information for the remote calling, an information storage server that provides pre-mapped coordinate information corresponding to installation location information of the location information provider when location information different from GPS location information is required, a parking location and guidance server that manages empty parking space information in a parking lot, controls parking guidance for the autonomous driving vehicle, and stores parking location information with respect to the autonomous driving vehicle, and a mobile device that communicates with the information storage server and the parking location and guidance server, generates transform GPS location information based on the coordinate information mapped in correspondence to location information of the location information provider and allows the transform GPS location information to be used as destination location information for the remote calling, or generates transform GPS location information for obtaining a parking destination based on input information received with reference to the empty parking space information when the autonomous driving vehicle starts the autonomous parking and allows the transform GPS location information to be used as destination location information for the autonomous parking.

According to still another aspect of the present disclosure, a short-range wireless communication device disposed underground includes a communication unit that performs short-range wireless communication, a memory storing at least one instruction, and a processor. When the at least one instruction is executed by the processor, the short-range wireless communication device initiates the short-range wireless communication with a mobile device requesting or intending to request autonomous departure for an autonomous driving vehicle located the underground, and the mobile device obtains GPS-format location information assigned to an installation location of the short-range wireless communication device using a signal received from the short-range wireless communication device after the short-range wireless communication is initiated and assigns the obtained location information to GPS information of the mobile device such that the autonomous driving vehicle moves the underground toward a location corresponding to the obtained location information.

The short-range wireless communication may include at least one of BLE, Wi-Fi, and UWB.

The short-range wireless communication with the mobile device may be performed while the mobile device is located the underground.

The location information may include floor-level information indicating an underground floor at which the short-range wireless communication device is installed. In this case, the short-range wireless communication device has the floor-level information of the underground location in which the autonomous driving vehicle is parked, and when the floor-level information indicating the installation location differs from floor-level information at which the autonomous driving vehicle is parked, the short-range wireless communication device may allow the mobile device to display that the floor-level of the mobile device differs from the parked floor-level of the autonomous driving vehicle.

A plurality of short-range wireless communication devices, including the short-range wireless communication device, may be provided in the underground. In this case, GPS-format location information corresponding to an installation location may be assigned to each of the plurality of short-range wireless communication devices.

The GPS-format location information may be included in the signal received from the short-range wireless communication device.

The GPS-format location information may be received from a predetermined information storage server.

The mobile device may release the obtained location information from location information of the mobile device when a predetermined release event occurs. In this case, the release event may include at least one of situations including when a signal is not received from the short-range wireless communication device or a strength of the signal is equal to or lower than a preset threshold, when the mobile device is paired with a Bluetooth device installed in the autonomous driving vehicle, when a mode-release beacon signal is detected from a mode-release beacon installed in the autonomous driving vehicle, when a preset time elapses after the obtained location information is assigned as the GPS information of the mobile device, when a GPS return beacon signal is received from a GPS return beacon installed at an exit from the underground to ground, when vehicle number information of the autonomous driving vehicle is received through a vehicle number recognition camera installed at the exit, when a user of the mobile device inputs completion of autonomous departure through the mobile device, and when parking location information of the autonomous driving vehicle is not confirmed or an exit information is received through cameras installed in the underground.

When a separation distance between a location corresponding to the obtained location information and the autonomous driving vehicle is within a preset distance, the autonomous driving vehicle may be called.

According to another aspect of the present disclosure, a parking location and guidance server includes a memory storing at least one instruction and a processor. When the at least one instruction is executed by the processor, the parking location and guidance server obtains input information for obtaining GPS-format location information from a mobile device requesting or intending to request autonomous departure for an autonomous driving vehicle located underground, determines the GPS-format location information based on the obtained input information, and transmits the GPS-format location information to the mobile device such that the GPS-format location information is applied to the mobile device while the mobile device is located the underground.

The input information may be obtained from the mobile device located the underground.

The input information may be information obtained in a process in which the mobile device performs short-range wireless communication with a short-range wireless communication device installed in the underground, information obtained by the mobile device reading a predetermined code attached in the underground, or information obtained by a user of the mobile device inputting the information into the mobile device.

The parking location and guidance server may have floor-level information of underground location at which the autonomous driving vehicle is parked. In this case, when floor-level information of the underground location at which the mobile device is located is different from the floor-level information of the underground location at which the autonomous driving vehicle is parked, the parking location and guidance server may allow the mobile device to display that a floor-level at which the mobile device is located is different from a parking floor-level of the autonomous driving vehicle.

The GPS-format location information may be obtained from information mapped to a signal received by the mobile device from a short-range wireless communication device installed in the underground.

The mobile device may release the obtained location information from location information of the mobile device when a predetermined release event occurs. In this case, the release event may include at least one of a case in which a signal is not received from a short-range wireless communication device installed in the underground or a strength of the signal is equal to or less than a preset threshold, a case in which the mobile device is paired and interoperates with a Bluetooth device provided in the autonomous driving vehicle, a case in which a mode-release beacon signal is detected from a mode-release beacon provided in the autonomous driving vehicle, a case in which a preset time elapses after the obtained location information is assigned as GPS information of the mobile device, a case in which a GPS return beacon signal is received from a GPS return beacon installed at an exit through which the autonomous driving vehicle moves from the underground to ground, a case in which vehicle number information of the autonomous driving vehicle is received by a predetermined vehicle number recognition camera installed at the exit through which the autonomous driving vehicle moves from the underground to the ground, a case in which a user of the mobile device inputs completion of autonomous departure through the mobile device, and a case in which parking location information of the autonomous driving vehicle is not confirmed or exit information is received through cameras installed in the underground.

When a separation distance between a location corresponding to the obtained location information and the autonomous driving vehicle is within a preset distance, the autonomous driving vehicle may be called.

According to an embodiment of the present disclosure, a method for supporting remote calling or autonomous parking may smoothly support remote calling or autonomous parking with respect to an autonomous driving vehicle in an area where GPS location information is not received from satellites or where reception sensitivity of GPS location information is weak.

In detail, transform GPS location information provided as substitute information for GPS location information may be provided as destination location information for remote calling or autonomous parking for an autonomous driving vehicle, and accordingly, remote calling or autonomous parking of the autonomous driving vehicle may be smoothly performed even in an area where reception sensitivity of GPS location information is weak.

In addition, by automatically detecting that the autonomous driving vehicle is located in an area where reception sensitivity of GPS location information is weak according to an occurrence of the first event or the second event, inaccurate GPS location information that may occur in various situations may be replaced with transform GPS location information representing an accurate location with respect to the autonomous driving vehicle.

### BRIEF DESCRIPTION OF THE DRAWINGS

FIG. 1 is a block diagram illustrating a location transform system, according to an embodiment of the present disclosure.

FIG. 2 is a block diagram illustrating a mobile device of FIG. 1.

FIG. 3 is a flowchart illustrating a remote-calling support operation in a mobile device, according to an embodiment of the present disclosure.

FIG. 4A is a block diagram illustrating a detailed control operation of a first operation mode of FIG. 3.

FIG. 4B is a block diagram illustrating another detailed control operation of a first operation mode of FIG. 3.

FIG. 4C is a block diagram illustrating still another detailed control operation of a first operation mode of FIG. 3.

FIG. 4D is a block diagram illustrating yet another detailed control operation of a first operation mode of FIG. 3.

FIG. 5 is a diagram schematically illustrating execution of remote calling, according to an embodiment of the present disclosure.

FIG. 6 is a flowchart illustrating an autonomous-parking support operation in a mobile device, according to an embodiment of the present disclosure.

FIG. 7 is a block diagram illustrating a detailed control operation of a second operation mode of FIG. 6.

FIG. 8 is a block diagram illustrating a location transform system, according to another embodiment of the present disclosure.

FIG. 9 is a diagram for describing an applicable range of a remote-calling support operation, according to an embodiment of the present disclosure.

FIG. 10 is a block diagram illustrating a location transform system having a sequential waiting operation, according to another embodiment of the present disclosure.

FIG. 11 is a flowchart illustrating a sequential-waiting control operation in an information storage server of FIG. 10.

### DETAILED DESCRIPTION

Autonomous driving vehicles may perform autonomous driving by obtaining required information related to driving from various sensors including radar or LiDAR, or by analyzing image information obtained through a monitoring camera.

Autonomous driving vehicles generally include a GPS receiver to obtain geographic location information required for an autonomous driving application. The GPS receiver receives a plurality of GPS signals from satellites positioned above the earth and provides GPS location information to an autonomous driving control device.

Recently, to enhance user convenience, remote calling technology, which calls an autonomous driving vehicle parked in a parking lot to a user location using a mobile device such as a smartphone, and autonomous parking technology, which controls an autonomous driving vehicle to autonomously park in an empty parking space without user boarding, are being developed or implemented.

However, when a GPS receiver mounted in an autonomous driving vehicle or a GPS receiver mounted in a mobile device fails to properly receive GPS signals in a reception shadow area such as an underground parking lot, functions of remote calling or autonomous parking are difficult to be properly achieved.

Accordingly, there is a strong demand for a technology capable of smoothly supporting the remote calling or the autonomous parking for autonomous driving vehicles in an area where GPS location information is not received from satellites or where reception sensitivity of GPS location information is weak.

The above and other objects, features, and advantages of the present disclosure will be readily understood through the following preferred embodiments described with reference to the accompanying drawings. However, the present disclosure is not limited to the embodiments described herein and may be embodied in other forms. Rather, the embodiments introduced herein are provided only to facilitate understanding and to ensure that the disclosure is thorough and complete and that the spirit of the present disclosure is fully conveyed to those skilled in the art.

In the present specification, when it is mentioned that an element or lines are connected to a target element block, it includes not only a direct connection but also an indirect connection to the target element block through another element.

In addition, the same or similar reference numerals illustrated in the drawings denote the same or similar components as much as possible. In some drawings, connection relationships of elements and lines are illustrated for effective explanation of technical content, and other elements or circuit blocks may be further provided.

Throughout the detailed description, references to “an embodiment” or “embodiments” mean that a particular feature, structure, or characteristic described in connection with the embodiment may be included in at least one embodiment disclosed in this specification. Accordingly, appearances of the phrases “in an embodiment”, “in embodiments”, or “according to an embodiment” or the like in various places throughout this specification do not necessarily refer to the same embodiment. Further, particular features, structures, or characteristics may be combined in any suitable manner in one or more embodiments. As used herein, the term “exemplary” means “serving as an example, instance, or illustration.” Any embodiment described herein as “exemplary” is not necessarily to be construed as preferred or advantageous over other embodiments. Also, depending on the context, singular terms may include plural forms, and plural terms may include singular forms. The various drawings illustrated and discussed herein, including component diagrams, are for illustrative purposes only and are not drawn to scale. Likewise, various waveforms and timing diagrams are illustrated only for illustrative purposes. For example, dimensions of some elements may be exaggerated relative to other elements for clarity. In addition, where appropriate, reference numerals are repeated among the drawings to indicate corresponding and/or similar elements.

The terminology used herein is for the purpose of describing particular exemplary embodiments only and is not intended to limit the claimed invention. As used herein, the singular forms “a”, “an”, and “the” are intended to include plural forms as well, unless the context clearly indicates otherwise. The terms “comprise” and/or “comprising”, when used in this specification, specify the presence of stated features, integers, steps, operations, elements, and/or components, but do not preclude the presence or addition of one or more other features, integers, steps, operations, elements, and/or components, and/or groups thereof. The terms “first”, “second”, and the like are used as labels for preceding nouns and do not imply any type of order unless explicitly defined otherwise. In addition, the same reference numerals may be used throughout two or more drawings to refer to parts, components, blocks, circuits, units, or modules having the same or similar functions. However, such usage is only for simplification of illustration and ease of discussion and does not mean that configurations or structural details of such components or units are the same across all embodiments, nor does it mean that such commonly referenced parts or modules are the only way of implementing guidelines of the specific embodiments disclosed herein.

Unless otherwise defined, all terms used herein, including technical and scientific terms, have the same meaning as commonly understood by those skilled in the art to which the present disclosure belongs. Terms defined in commonly used dictionaries should be interpreted as having meanings consistent with their meanings in the context of the related art and should not be interpreted in an idealized or overly formal sense unless expressly so defined herein.

As used herein, the term “module” refers to any combination of software, firmware, and/or hardware configured to provide a function described in this specification with respect to the module. The term “software” may be implemented, as applied to any implementation described herein, as a software package, code, and/or an instruction set or instructions. The term “hardware” may include, as applied to any implementation described herein, for example, individual or any combination of hardwired circuitry, programmable circuitry, state machine circuitry, and/or firmware that stores instructions executed by programmable circuitry. The modules, collectively or individually, may be implemented as circuits forming part of a larger system, such as an integrated circuit or a system on chip (SoC), but are not limited thereto.

Each embodiment described and illustrated herein may also include a complementary embodiment thereof, and image processing operations for vehicles or parking spaces, conventional parking-location confirmation and parking-guidance operations, and detailed operations and functions of a Bluetooth beacon or module or vehicle number recognition will not be described in detail so as not to obscure the gist of the present disclosure.

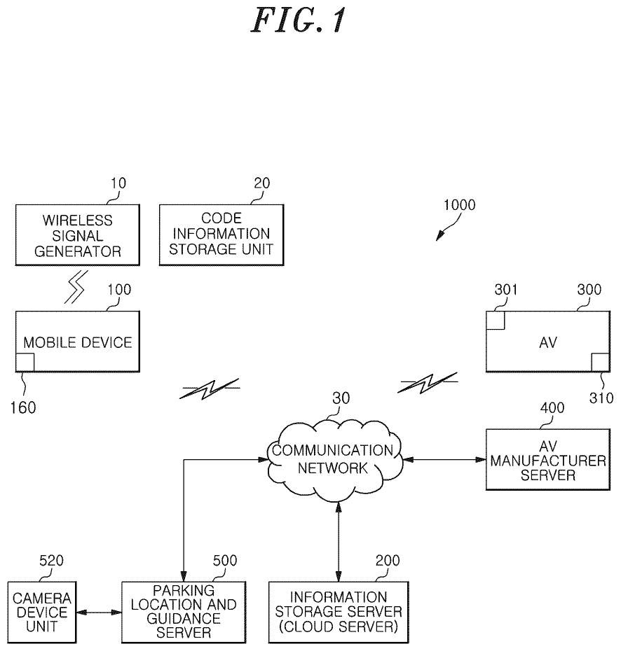

FIG. 1 is a block diagram illustrating a location transform system, according to an embodiment of the present disclosure.

Referring to FIG. 1, a location transform system 1000 may include a wireless signal generator 10, a code information storage unit 20, a communication network 30, a mobile device 100, an information storage server 200, and a parking location and guidance server 500, so as to support remote calling or autonomous parking of an autonomous driving vehicle (AV) 300.

The wireless signal generator 10 may be a BLE beacon, a UWB (Ultra-wideband) transmitter, or a Wi-Fi device. The BLE beacon, the UWB transmitter, and the Wi-Fi device may output a unique ID related to location information. For example, when a beacon signal output from the BLE beacon includes a unique ID having a value of #0001, the unique ID of #0001 may be mapped, in the information storage server 200, to coordinate values corresponding to an installation location or a designated location of the BLE beacon. Accordingly, when the unique ID of the wireless signal generator 10 is obtained, coordinate values corresponding to the unique ID may be identified through the information storage server 200.

Alternatively, the BLE beacon, the UWB transmitter, and the Wi-Fi device may directly output coordinate values indicating latitude and longitude depending on location information. That is, in this case, coordinate values indicated by the wireless signal generator 10 may be directly obtained without using the information storage server 200.

The code information storage unit 20 may store a QR code or a barcode. Information included in the QR code may be a unique ID related to location information or coordinate values. When the QR code includes a unique ID having a value of #0002, the unique ID of #0002 may be mapped, in the information storage server 200, to coordinate values corresponding to an installation location or a designated location of the code information storage unit 20. Accordingly, when the unique ID of the code information storage unit 20 is obtained, coordinate values corresponding to the unique ID may be identified through the information storage server 200.

The communication network 30 may include an LTE network and a TCP/IP network. The communication network 30 may establish data communication between the mobile device 100 and the information storage server 200. The communication network 30 may establish data communication between the mobile device 100 and a manufacturer server 400 of the autonomous driving vehicle AV. In addition, the communication network 30 may establish data communication between the mobile device 100 and the parking location and guidance server 500. When a communication interface of the communication network 30 is a wired interface, the data communication may include not only TCP/IP communication but also UART serial communication such as RS422 and RS485, and CAN communication.

The information storage server 200 may store coordinate values corresponding to a unique ID of the wireless signal generator 10 or a unique ID of the code information storage unit 20. When the unique ID of the wireless signal generator 10 or the unique ID of the code information storage unit 20 is received, the information storage server 200 may output coordinate data corresponding to the unique ID. The information storage server 200 may change the coordinate data corresponding to the unique ID to new coordinate data in response to a mapping-information update request. That is, the mapping-information update request may occur when it is necessary to change coordinate values corresponding to the unique ID. The information storage server 200 may be implemented as a cloud server.

The parking location and guidance server 500 may identify a parking location at which a vehicle is parked. The parking location and guidance server 500 may perform parking guidance such that the vehicle is parked in an empty parking space. The empty parking space may refer to a parking space in which another vehicle is not parked and which is vacant. In some cases, the empty parking space may be a parking space within a preferred zone preferred by a user. In other cases, the empty parking space may be a parking space within a fire safety zone provided to separately park a vehicle having a risk of fire.

The parking location and guidance server 500 may recognize a vehicle number and perform parking location identification and parking guidance. For this purpose, the parking location and guidance server 500 may be connected to a camera device unit 520. The camera device unit 520 may include cameras having a license plate recognition(LPR) function for vehicles entering a parking lot and cameras having an image recognition function.

The parking location and guidance server 500 may recognize, through a sensing device or the camera device unit 520, whether a vehicle is parked in each of parking spaces of an underground parking lot or whether a parking space is vacant. The parking location and guidance server 500 may also be connected, wiredly or wirelessly, to a parking-guidance electronic display board for performing parking guidance. The parking location and guidance server 500 may communicate with the camera device unit 520 to perform parking guidance for vehicles entering an underground parking lot and to recognize parking locations where the vehicles are parked.

The parking location and guidance server 500 may include an image analyzer. The image analyzer may be implemented as a dedicated analysis server. The image analyzer may analyze image data provided from the camera device unit 520 of the parking-lot, according to a preset dedicated program. The image analyzer may perform image classification.

When a preferred parking zone preferred by a user is stored or designated in advance, the parking location and guidance server 500 may guide the autonomous driving vehicle 300 to an empty parking space among parking spaces in the preferred parking zone.

In an embodiment, the parking location and guidance server 500 may include the information storage server 200, or the two servers may be integrated and operated as a single server. In addition, depending on embodiments, when each of the information storage server 200 and the parking location and guidance server 500, or one (e.g., the information storage server 200) of the information storage server 200 and the parking location and guidance server 500, is implemented to be included in the other (e.g., the parking location and guidance server 500), a cloud-server form may be employed.

The autonomous driving vehicle 300 may perform autonomous driving under control of a vehicle controller. For this purpose, the autonomous driving vehicle 300 may include a sensing device 301 and an autonomous driving vehicle (AV) driving application 310. The autonomous driving vehicle 300 may be an electric vehicle equipped with a battery, but embodiments of the present disclosure are not limited thereto.

The sensing device 301 of the autonomous driving vehicle 300 may include a sensor unit including an ultrasonic sensor and may include a vision-based camera. Accordingly, the sensing device 301 of the autonomous driving vehicle 300 may detect physical elements such as a lane, a wall, a pillar, and another vehicle as obstacles. The autonomous driving vehicle 300 may set a travel path to avoid obstacles recognized through the sensing device 301 and may autonomously move under control of the AV driving application 310. The AV driving application 310 may be a full self-driving (FSD) application.

The AV driving application 310 of the autonomous driving vehicle 300 may be stored in a memory of the vehicle controller and may be an application program for performing a remote-calling function and an autonomous-parking function.

The autonomous driving vehicle 300 may communicate with the AV manufacturer server 400 through the communication network 30. The autonomous driving vehicle 300 may communicate with the mobile device 100 through the communication network 30. The AV manufacturer server 400 may communicate with the mobile device 100 through the communication network 30. The autonomous driving vehicle 300 may communicate with the mobile device 100 through short-range wireless communication, for example, Bluetooth communication.

The mobile device 100 may be, but is not limited to, a smartphone capable of performing mobile communication. The mobile device 100 may include a memory unit 160. An AV control application for controlling remote calling or autonomous parking of the autonomous driving vehicle 300 and a location transform application for supporting remote calling or autonomous parking of the autonomous driving vehicle 300 may be stored in the memory unit 160.

In an embodiment of the present disclosure, when the AV control application is executed, the mobile device 100 may support the remote calling of the autonomous driving vehicle 300 through the location transform application as described below. When the AV control application is executed, the mobile device 100 may support the autonomous parking using autonomous driving of the autonomous driving vehicle 300 through the location transform application as described below.

Accordingly, the remote calling or the autonomous parking may be smoothly supported for the autonomous driving vehicle 300 even in an area where GPS location information is not received from satellites or where reception sensitivity of GPS location information is weak.

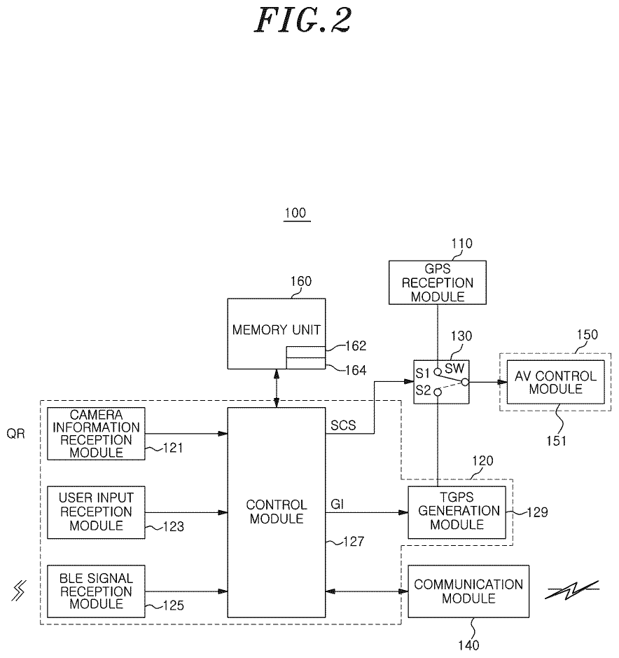

FIG. 2 is a block diagram illustrating the mobile device 100 of FIG. 1.

Referring to FIG. 2, the mobile device 100 may include a GPS reception module 110, a location transform object part 120, a switching unit 130, a communication module 140, an AV control application object part 150, and the memory unit 160.

The GPS reception module 110 receives GPS location information in a normal mode in which the GPS location information is received from satellites. The GPS reception module 110 may basically include a phase locked loop for converting satellite signals provided from GPS satellites into intermediate-frequency signals and obtaining synchronization between the converted signals and an internal PRN code, and a signal processing unit that receives and processes an output of the phase locked loop to output a positioning result.

The location transform object part 120 is a set of modules driven while the location transform application is executed, and may include a camera information reception module 121, a user input reception module 123, a BLE signal reception module 125, a control module 127, and a transform GPS (TGPS) generation module 129.

The switching unit 130 functions as a software switch and switches, through a switch SW, one of GPS location information and TGPS location information depending on a logic state of a switching control signal SCS.

The communication module 140 may perform data communication through a wireless interface. Protocols used for the wireless interface may include protocols such as Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service-Time Division Duplex (UMTS-TDD), High Speed Packet Access (HSPA), Evolution Data Optimized (EVDO), Long Term Evolution Advanced (LTE Advanced), Multichannel Multipoint Distribution Service (MMDS), and others.

The AV control application object part 150 is a module driven when an AV control application 162 is executed, and may include an AV control module 151.

The memory unit 160 may store the AV control application 162 and a location transform application 164. The AV control application 162 and the location transform application 164 may interoperate to each other, and when the AV control application 162 is executed, the location transform application 164 may operate as a background application. Alternatively, although not limited thereto, the location transform application 164 may operate as a foreground application or a background application before the AV control application 162 is executed.

The memory unit 160 may store, in a volatile or non-volatile manner, user data and various data related to remote calling and autonomous parking. The memory unit 160 may store application programs and data required for supporting and controlling the remote calling and the autonomous parking of the present disclosure. The memory unit 160 may include at least one type of storage medium among memories such as a flash memory type, a hard disk type, a micro type, and a card type, (e.g., an SD card (Secure Digital Card) or an XD card (eXtream Digital Card), and memories such as a RAM(Random Access Memory), an SRAM(Static RAM), a ROM(Read-Only Memory), a PROM(Programmable ROM), an EEPROM(Electrically Erasable PROM), an MRAM(Magnetic RAM), a magnetic disk, and an optical disk.

The AV control application 162 may drive the AV control module 151 of the AV control application object part 150. The AV control application 162 may be an application program or software for controlling the remote calling or the autonomous parking of the autonomous driving vehicle 300 through the mobile device 100.

The location transform application 164 may be an application program or software for supporting the remote calling or the autonomous parking of the autonomous driving vehicle 300 through the mobile device 100. The location transform application 164 may drive modules of the location transform object part 120.

While the location transform application 164 is executed, the camera information reception module 121 may receive camera information received through a camera of the mobile device 100, for example, QR code information or barcode information.

While the location transform application 164 is executed, the user input reception module 123 may receive information input from a user of the mobile device 100 through a touch panel or the like.

While the location transform application 164 is executed, the BLE signal reception module 125 may receive a beacon signal. In an embodiment of the present disclosure, the BLE signal reception module 125 is illustrated by way of example. However, the present disclosure is not limited thereto, and the BLE signal reception module 125 may further include a UWB signal reception module or a Wi-Fi signal reception module.

The camera information reception module 121, the user input reception module 123, or the BLE signal reception module 125 may be referred to as an event detection module since it is a module for detecting whether an event requiring location information different from GPS location information occurs, i.e., when location information other than GPS location information is required.

The control module 127 may be a module for controlling and supporting the remote calling or the autonomous parking of the autonomous driving vehicle 300. The control module 127 may be implemented using, for example, a processor, a controller, an ALU(arithmetic logic unit), a digital signal processor(digital signal processor), a microcomputer, an FPGA(field programmable gate array), a PLU(programmable logic unit), or a microprocessor. Alternatively, the control module 127 may be implemented using a ‘Snapdragon 8 Elite’ chipset or an ‘A18’ chipset capable of executing and responding to instructions. The chipset may include an NPU, a CPU, and a GPU so that data processing may be performed in an interworking manner.

The control module 127 may execute an operating system (OS) and one or more software applications executed on the operating system. In addition, the control module 127 may access, store, manipulate, process, and generate data in response to execution of software. For convenience of understanding and illustration, the control module 127 is described as a single component. However, those of ordinary skill in the art will appreciate that a processing device may include a plurality of processing elements and/or a plurality of types of processing elements. For example, the control module 127 may include a plurality of processors, or one processor and one controller. In addition, other processing configurations, such as a parallel processor, are also possible. The software may include a computer program, code, an instruction, or a combination of one or more thereof, and may configure a device to operate as desired or may instruct the device independently or collectively. The software and/or data may be embodied permanently or temporarily in any type of machine, component, physical device, virtual equipment, computer storage medium or device, or a transmitted signal wave, to be interpreted by the device or to provide instructions or data to the device. In some cases, the software may be distributed over computer systems connected through a network and thus stored or executed in a distributed manner. The software and data may be stored in one or more computer-readable recording media or memories.

The control module 127 may execute, in parallel, the AV control application 162 and the location transform application 164 stored in the memory unit 160.

The transform GPS (TGPS) generation module 129 may generate TGPS location information according to an embodiment of the present disclosure. The transform GPS (TGPS) generation module 129 may generate TGPS location information according to geographic information GI applied from the control module 127. For example, a number of data bits of the TGPS location information may be the same as a number of data bits of the GPS location information output from the GPS reception module 110. The TGPS generation module 129 may generate the TGPS location information based on input information (e.g., the geographic information GI) obtained when an occurrence of a first event (e.g., a remote-calling event) is detected. When the TGPS generation module 129 directly receives coordinate values related to latitude and longitude as the TGPS location information, the TGPS generation module 129 may function as a data bit formatter for outputting the TGPS location information having the same number of bits as the GPS location information.

Accordingly, when the occurrence of the first event is detected, the control module 127 may transition or enter, from the normal mode, a first operation mode for supporting the remote calling of the autonomous driving vehicle. In the first operation mode, the control module 127 may allow the transform GPS location information generated by the TGPS generation module 129 to be provided as destination location information for the remote calling.

In more detail, in the normal mode, the control module 127 may provide the switching control signal SCS having a high-level to the switching unit 130. Accordingly, the switch SW of the switching unit 130 causes the GPS location information received from the GPS reception module 110 to be provided to the AV control module 151. Therefore, when the AV control module 151 receives the GPS location information, the AV driving application 310 of the autonomous driving vehicle 300 may control the remote calling or the autonomous parking based on the GPS location information.

Meanwhile, the autonomous driving vehicle 300 may be parked in an area where GPS location information is not received from satellites or where reception sensitivity of the GPS location information is weak, for example, an underground parking lot. In addition, the mobile device 100 carried by a user of the autonomous driving vehicle 300 may also be located in an underground parking lot or the like. When the autonomous driving vehicle 300 or the mobile device 100 is located in a GPS shadow area as described above, the GPS location information is not received from satellites through the GPS reception module 110, or a signal strength of the GPS location information received from the GPS reception module 110 is weak. Accordingly, in a GPS shadow area such as an underground parking lot, it is difficult to properly implement the remote calling or the autonomous parking.

Accordingly, for example, while the location transform application 164 is executed, when the user is located at a common entrance of the underground parking lot, the mobile device 100 of the user may receive, through the BLE reception module 125, a BLE beacon signal installed near the common entrance.

The control module 127 may transmit, through the communication module 140, a beacon ID included in the BLE beacon signal to the information storage server 200. In response to the transmitted beacon ID, the information storage server 200 may transmit, through the communication module 140, coordinate value information including latitude and longitude mapped to the beacon ID to the control module 127. Accordingly, the control module 127 may receive the coordinate value information and transfer the coordinate value information to the transform GPS (TGPS) generation module 129 as the geographic information GI. In response to the geographic information GI, the TGPS generation module 129 may generate the TGPS location information.

In this case, the control module 127 may provide the switching control signal SCS having a low-level to the switching unit 130. Accordingly, the switch SW of the switching unit 130 causes the TGPS location information generated by the TGPS generation module 129 to be provided to the AV control module 151. Therefore, the AV control module 151 for controlling driving of the autonomous driving vehicle 300 may receive the TGPS location information. When the AV control module 151 receives the TGPS location information, the AV driving application 310 of the autonomous driving vehicle 300 may control the remote calling or the autonomous parking based on the TGPS location information.

Meanwhile, even when the camera information reception module 121 receives QR code information, coordinate value information mapped to the QR code information may be obtained from the information storage server 200. When the QR code information itself includes coordinate value information, the TGPS location information may be directly generated by the TGPS generation module 129 without reliance on the information storage server 200.

Likewise, when coordinate value information is input through the user input reception module 123, the TGPS location information may be directly generated by the TGPS generation module 129 without reliance on the information storage server 200. However, when a specific ID is input through the user input reception module 123, mapped coordinate value information may be obtained from the information storage server 200.

As in the above description, when the BLE beacon signal may include coordinate value information, the TGPS location information may be directly generated by the TGPS generation module 129 without reliance on the information storage server 200.

In an embodiment, the above-described TGPS location information generation operation of the TGPS generation module 129 may also be performed in the parking location and guidance server 500, and when the TGPS location information is generated in the parking location and guidance server 500, the generated TGPS location information may be transmitted from the parking location and guidance server 500 to the mobile device 100.

As described above, by execution of the location transform application 164, the remote calling or the autonomous parking can be smoothly supported for the autonomous driving vehicle 300 even in an area where GPS location information is not received from satellites or where reception sensitivity of GPS location information is weak.

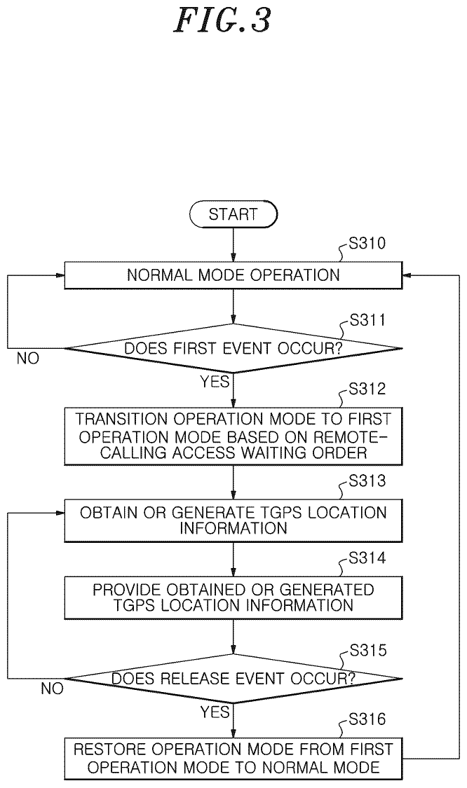

FIG. 3 is a flowchart illustrating a remote-calling support operation in a mobile device, according to an embodiment of the present disclosure.

Referring to FIG. 3 together with FIGS. 1 and 2, in operation S310, the control module 127 of the mobile device 100 may perform a normal mode operation. In this case, the control module 127 may output the switching control signal SCS having a high-level to the switching unit 130. Accordingly, the GPS location information received from the GPS reception module 110 may be provided to the AV control module 151. In the normal mode operation, the location transform application 164 may be executed as a background application of the mobile device 100.

Even when the autonomous driving vehicle 300 is parked in an underground parking lot that may be a GPS shadow area, the user may generate the remote calling (or a smart summon) using the mobile device 100. When the remote calling is generated, execution of the AV control application 162 is started.

In operation S311, the control module 127 of the mobile device 100 may determine whether the first event occurs. The first event may occur when the mobile device 100 carried by the user of the autonomous driving vehicle 300 receives a wireless signal in a specific area of the underground parking lot for remote calling.

For example, when the wireless signal is received from at least one wireless signal generator (e.g., the BLE signal reception module 125) installed in a reception shadow area, the control module 127 may determine that the first event occurs. In this case, a distance between the autonomous driving vehicle 300 and a remote-calling destination may be within 70 meters.

In addition, when code information is obtained from at least one QR code installed in the reception shadow area, the control module 127 may determine that the first event occurs. In this case, when the user captures an image of the QR code, the camera information reception module 121 may receive the captured QR code. In this case, the distance between the autonomous driving vehicle 300 and the remote-calling destination may be within 70 meters.

In addition, when, in the reception shadow area, the user of the mobile device 100 directly inputs the destination location information for the remote calling, or when the user selects the destination location information for the remote calling from a coordinate table of the underground parking lot through a screen of the mobile device 100, the control module 127 may determine that the first event occurs. In this case, the distance between the autonomous driving vehicle 300 and the remote-calling destination may be within 70 meters.

In addition, when, at a common entrance lobby phone installed in the reception shadow area, the user of the mobile device 100 performs fingerprint recognition or facial recognition and destination location information for the remote calling mapped in correspondence to the fingerprint recognition or facial recognition of the user is received from a home network server that communicates with the common entrance lobby phone, the control module 127 may determine that the first event occurs. In this case, the distance between the autonomous driving vehicle 300 and the remote-calling destination may be within 70 meters.

In addition, in response to a parking-location identification request, when destination location information for the remote calling mapped in correspondence to a camera installed near (or closest to) where the autonomous driving vehicle 300 is parked and that performs vehicle number recognition is received from the parking location and guidance server that performs vehicle number recognition through cameras in the reception shadow area and controls parking location and guidance, the control module 127 may determine that the first event occurs. In this case, the distance between the autonomous driving vehicle 300 and the remote-calling destination may be within 6 meters. In addition, the distance between the autonomous driving vehicle 300 and the mobile device 100 may exceed 6 meters.

In addition, when destination location information for the remote calling mapped in correspondence to a camera installed near where the autonomous driving vehicle 300 is parked and that performs vehicle number recognition is received from the parking location and guidance server that responds to vehicle information obtained by capturing while the autonomous driving vehicle 300 is parked, the control module 127 may determine that the first event occurs. In this case, the distance between the autonomous driving vehicle 300 and the remote-calling destination may be within 6 meters. In addition, the distance between the autonomous driving vehicle 300 and the mobile device 100 may also be within 6 meters.

In addition, when a wireless signal is received from the wireless signal generator 10 in a state in which vehicle information is obtained by capturing while the autonomous driving vehicle 300 is parked, the control module 127 may determine that the first event occurs. In this case, the distance between the autonomous driving vehicle 300 and the remote-calling destination may be within 6 meters. In addition, the distance between the autonomous driving vehicle 300 and the mobile device 100 may also be within 6 meters.

In addition, when destination location information for the remote calling mapped in correspondence to code information obtained by capturing a QR code installed near where the autonomous driving vehicle 300 is parked is received, the control module 127 may determine that the first event occurs. In this case, the distance between the autonomous driving vehicle 300 and the remote-calling destination may be within 6 meters. In addition, the distance between the autonomous driving vehicle 300 and the mobile device 100 may also be within 6 meters.

When the first event occurs in operation S311, in operation S312, the control module 127 of the mobile device 100 may transition an operation mode to the first operation mode. That is, the control module 127 of the mobile device 100 may change the operation mode from the normal mode operation to the first operation mode. In this case, the control module 127 of the mobile device 100 may output the switching control signal SCS having a low-level. Accordingly, the switch SW of the switching unit 130 is connected to a switching node S2 so that, when the TGPS location information is generated by the TGPS generation module 129, the TGPS location information may be provided to the AV control module 151.

Meanwhile, the change from the normal mode operation to the first operation mode may be performed based on a remote-calling access waiting order. When a plurality of users perform the remote calling at the same remote-calling destination, a plurality of autonomous driving vehicles may move to the same remote-calling destination at once. In such a case, congestion or blockage due to vehicles in the underground parking lot may occur. To prevent this, the information storage server 200 may provide, to a plurality of mobile devices, order information related to the remote calling, as described below.

In operation S313, the control module 127 of the mobile device 100 may obtain TGPS location information. In addition, the control module 127 of the mobile device 100 may control the TGPS generation module 129 to generate the TGPS location information.

The obtaining of TGPS location information may be accomplished when the TGPS location information is directly provided to the user input reception module 123. For example, the TGPS location information may be obtained when coordinate values including latitude and longitude are directly given. Meanwhile, generation of the TGPS location information may be performed when the TGPS generation module 129 obtains coordinate values including latitude and longitude based on the geographic information GI applied from the control module 127. For example, when coordinate values mapped in correspondence to a unique ID of the wireless signal generator 10 are provided from the information storage server 200, the TGPS generation module 129 may generate the TGPS location information having the same number of bits as data bits of GPS information as destination information for the remote calling. In this case, the destination information for the remote calling refers to a geographic point at which the autonomous driving vehicle 300 will arrive in response to the remote calling, and may indicate a point at which the mobile device 100 is located or nearby geographic location information.

In operation S314, the control module 127 of the mobile device 100 may provide the TGPS location information provided from the TGPS generation module 129 to the switching unit 130. The switching unit 130 may allow the TGPS location information to be applied to the AV control module 151. Accordingly, the AV control module 151 may receive the TGPS location information as destination information for the remote calling. When the AV control module 151 receives the TGPS location information, the AV driving application 310 of the autonomous driving vehicle 300 may control the remote calling based on the TGPS location information. By the remote calling, the autonomous driving vehicle 300 may be called to a coordinate point in the underground parking lot indicated by the TGPS location information, which is the destination information for the remote calling.

Ultimately, by execution of the location transform application 164, the TGPS location information may be provided, and thus the remote calling may be smoothly supported for the autonomous driving vehicle 300 even in an underground parking lot.

In operation S315, the control module 127 of the mobile device 100 may determine whether a release event for the first event occurs.

The release event for the first event may occur when a wireless signal generated from the wireless signal generator 10 involved in an occurrence of the first event is not received or is weak to a set sensitivity or lower. In addition, the release event for the first event may occur when a Bluetooth device installed in the autonomous driving vehicle 300 and the mobile device 100 interoperate through pairing. In addition, the release event for the first event may occur when a beacon signal is received from a mode-release BLE beacon separately installed in the autonomous driving vehicle 300. In addition, the release event for the first event may occur when a time (e.g., 7 minutes) set in relation to the first event elapses. In addition, the release event for the first event may occur when the autonomous driving vehicle 300 exits to the outside at an exit of the underground parking lot and a beacon signal is received from a GPS return beacon installed at the exit of the underground parking lot. In addition, the release event for the first event may occur when the user of the mobile device 100 directly provides a release input for the first event through the mobile device 100. In addition, the release event for the first event may occur when parking location information is not confirmed or exit information is received from the parking location and guidance server 500 that performs vehicle number recognition through cameras and controls parking location and parking guidance in the underground parking lot.

When the release event for the first event occurs, in operation S316, the control module 127 of the mobile device 100 may control an operation mode of the mobile device to restore from the first operation mode to the normal mode. In this case, the control module 127 of the mobile device 100 may apply the switching control signal SCS having a high-level to the switching unit 130. Accordingly, the switch SW of the switching unit 130 returns and is connected to a switching node S1. Therefore, the GPS location information received through the GPS reception module 110 may be provided to the AV control module 151. Accordingly, the AV driving application 310 of the autonomous driving vehicle 300 may operate based on the GPS location information.

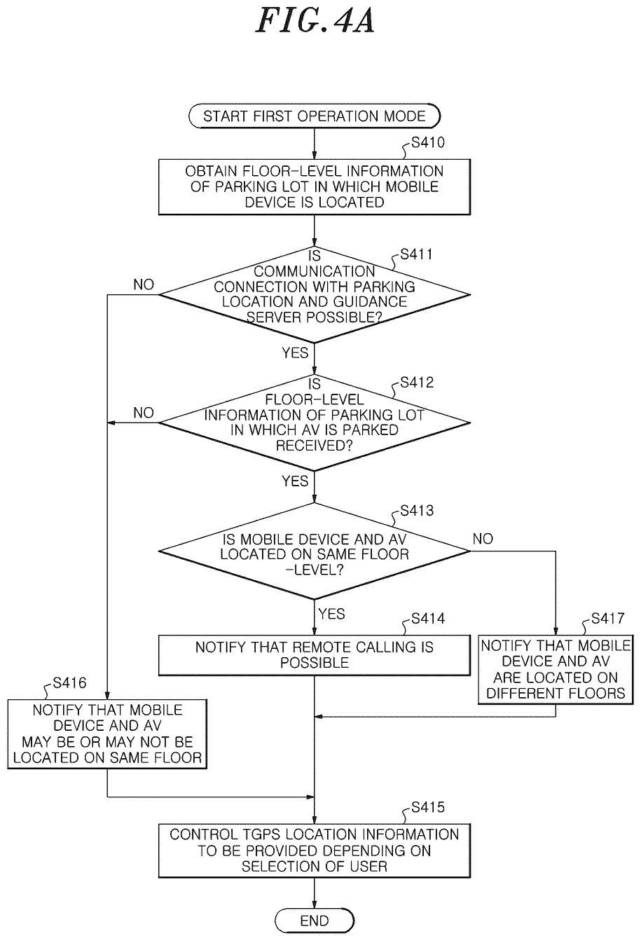

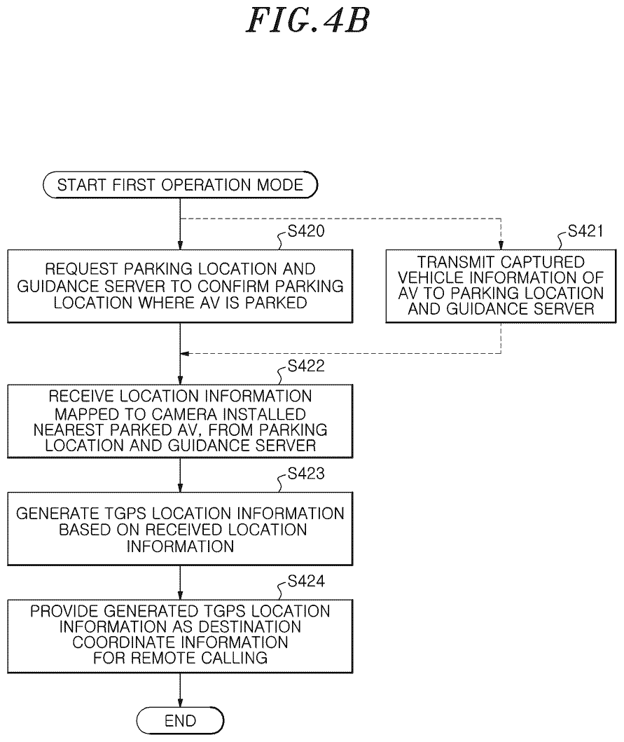

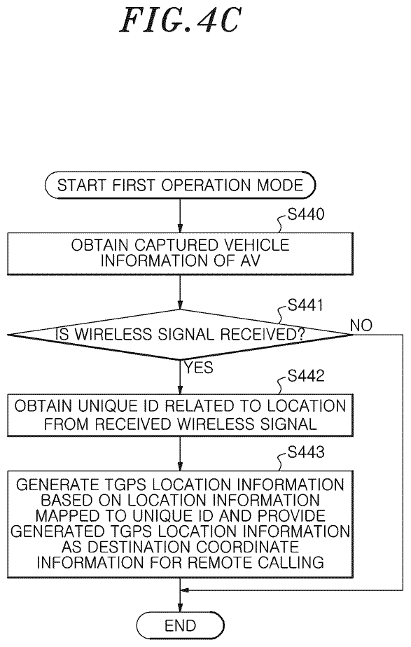

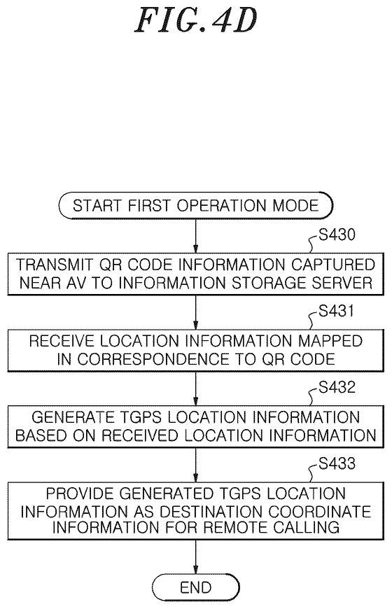

FIG. 4A is a block diagram illustrating a detailed control operation of a first operation mode of FIG. 3.

In operation S410, the control module 127 of the mobile device 100 may obtain floor-level information of a parking lot. A signal transmitted from the wireless signal generator 10 may include a unique ID, and the unique ID may include floor-level information of a parking lot in which the wireless signal generator 10 is located. Accordingly, the control module 127 of the mobile device 100 may obtain the floor-level information of the parking lot from the wireless signal generator 10 or the code information storage unit 20. Ultimately, the floor-level information of the parking lot may indicate information of a floor on which the mobile device 100 is located. Alternatively, the control module 127 of the mobile device 100 may obtain the floor-level information of the parking lot from the information storage server 200 that stores various types of information mapped with the unique ID of the wireless signal generator 10 or the code information storage unit 20.

In operation S411, the control module 127 of the mobile device 100 may determine whether a communication connection with the parking location and guidance server 500 is possible. When the parking location and guidance server 500 of FIG. 1 is not installed or communication is disconnected through the communication network 30, the control module 127 of the mobile device 100 may determine that a communication connection between the mobile device 100 and the parking location and guidance server 500 is not possible. When the communication connection between the mobile device 100 and the parking location and guidance server 500 is possible, the parking location and guidance server 500 may provide floor-level information of the autonomous driving vehicle 300 since the parking location and guidance server 500 may confirm the floor-level and the parking location where the autonomous driving vehicle 300 is parked in the underground parking lot.

When the communication connection with the parking location and guidance server is possible in operation S411, in operation S412, the control module 127 of the mobile device 100 may determine whether floor-level information of the parking lot in which the autonomous driving vehicle 300 is parked is received.

In operation S413, the control module 127 of the mobile device 100 may determine whether the mobile device 100 and the autonomous driving vehicle 300 are located on the same floor by comparing floor-level information of the mobile device 100 with floor-level information of the parking lot in which the autonomous driving vehicle 300 is parked.

When it is determined in operation S413 that the mobile device 100 and the autonomous driving vehicle 300 are located on the same floor, in operation S414, the control module 127 of the mobile device 100 may notify, through a display screen of the mobile device 100, that remote calling is possible on the same floor of the underground parking lot.

In operation S415, the control module 127 of the mobile device 100 may control the TGPS location information to be provided for the remote calling according to selection of the user of the mobile device 100.

When the communication connection with the parking location and guidance server is not possible in operation S411 and the parking-lot floor-level information is not received in operation S412, in operation S416, the control module 127 of the mobile device 100 may notify, through the display screen of the mobile device 100, that the mobile device 100 and the autonomous driving vehicle 300 may be located on the same floor or may not be located on the same floor.

When it is determined in operation S413 that the mobile device 100 and the autonomous driving vehicle 300 are located on different floors, in operation S417, the control module 127 of the mobile device 100 may notify, through the display screen of the mobile device 100, that the mobile device 100 and the autonomous driving vehicle 300 are located on different floors.

The detailed control operation of the first operation mode in FIG. 4A describes that the remote calling may be smoothly performed when the mobile device 100 and the autonomous driving vehicle 300 are located on the same floor. However, it should be understood that the TGPS location information for the remote calling may be provided according to user selection even when the mobile device 100 and the autonomous driving vehicle 300 are located on different floors.

FIG. 4B is a block diagram illustrating another detailed control operation of a first operation mode of FIG. 3.

Referring to FIG. 4B, in operation S420, the control module 127 of the mobile device 100 may request the parking location and guidance server 500 to confirm a parking location where the autonomous driving vehicle 300 is parked. In this case, the mobile device 100 does not need to be located in the underground parking lot.

In operation S422, the control module 127 of the mobile device 100 may receive, from the parking location and guidance server 500, location information mapped to a camera installed near the parked autonomous driving vehicle 300 and that performs vehicle number recognition. When parking-location confirmation for the autonomous driving vehicle 300 is requested from the mobile device 100, the parking location and guidance server 500 may search, within the camera device unit 520, for a nearby camera that performs vehicle number recognition corresponding to a location where the autonomous driving vehicle 300 is parked. The parking location and guidance server 500 may provide location information mapped in correspondence to the camera installed near where the autonomous driving vehicle 300 is parked and that performs vehicle number recognition.

In operation S423, the control module 127 of the mobile device 100 may generate the TGPS location information based on the received location information.

In operation S424, the control module 127 of the mobile device 100 may provide the generated TGPS location information as destination coordinate information for the remote calling.

In the case of FIG. 4B, a distance between the autonomous driving vehicle 300 and the remote-calling destination (e.g., the TGPS location information mapped to a camera installed near the parked autonomous driving vehicle 300 and that performs vehicle number recognition) may be, for example, within 6 meters. In addition, a distance between the autonomous driving vehicle 300 and the mobile device 100 may exceed 6 meters without being limited thereto.

Meanwhile, upon the remote calling, operation S421 may be provided to limit a distance between the autonomous driving vehicle 300 and the mobile device 100 to within 6 meters.

Operation S421 is provided to limit the distance between the autonomous driving vehicle 300 and the mobile device 100 to within 6 meters. In operation S421, the user may capture an image of the vehicle number of the autonomous driving vehicle 300 using the mobile device 100. The captured vehicle number of the autonomous driving vehicle 300 may be transmitted to the parking location and guidance server 500.

After operation S421 is performed, the control module 127 of the mobile device 100 may proceed to the above-described operation S422.

FIG. 4C is a block diagram illustrating still another detailed control operation of a first operation mode of FIG. 3.

Referring to FIG. 4C, in operation S440, the control module 127 of the mobile device 100 may obtain captured vehicle information (e.g., a license plate number of the vehicle) of the autonomous driving vehicle 300. For this purpose, the user may capture an image of the vehicle number of the autonomous driving vehicle 300 using the mobile device 100 in the underground parking lot. The captured vehicle number may be provided to the parking location and guidance server 500.

In a state in which vehicle information of the autonomous driving vehicle 300 is obtained by the capturing operation, in operation S441, the control module 127 of the mobile device 100 may determine whether a wireless signal is received. When a beacon signal is received from the wireless signal generator 10 installed near where the autonomous driving vehicle 300 is parked and which may be a BLE beacon, in operation S442, the control module 127 of the mobile device 100 may obtain a unique ID related to location from the received wireless signal.

In operation S443, the control module 127 of the mobile device 100 may generate the TGPS location information based on location information mapped to the unique ID. The control module 127 of the mobile device 100 may provide the generated TGPS location information as destination coordinate information for the remote calling.

In the case of FIG. 4C, the distance between the autonomous driving vehicle 300 and the remote-calling destination may be set to, for example, within 6 meters. In addition, the distance between the autonomous driving vehicle 300 and the mobile device 100 may also be set to within 6 meters.

FIG. 4D is a block diagram illustrating still another detailed control operation of a first operation mode of FIG. 3.

Referring to FIG. 4D, in operation S430, the control module 127 of the mobile device 100 may transmit, to the information storage server 200, QR code information captured near a parking location of the autonomous driving vehicle 300. For this purpose, the user may capture an image of a QR code near the parking location of the autonomous driving vehicle 300. In addition, the information storage server 200 may search a mapping table for location information corresponding to the received QR code and may provide the location information.

In operation S431, the control module 127 of the mobile device 100 may receive location information mapped in correspondence to the QR code.

In operation S432, the control module 127 of the mobile device 100 may generate the TGPS location information based on the received location information.

In operation S433, the control module 127 of the mobile device 100 may provide the generated TGPS location information as destination coordinate information for the remote calling.

In this case, the distance between the autonomous driving vehicle 300 and the remote-calling destination may be, for example, within 6 meters. In addition, the distance between the autonomous driving vehicle 300 and the mobile device 100 may also be within 6 meters.

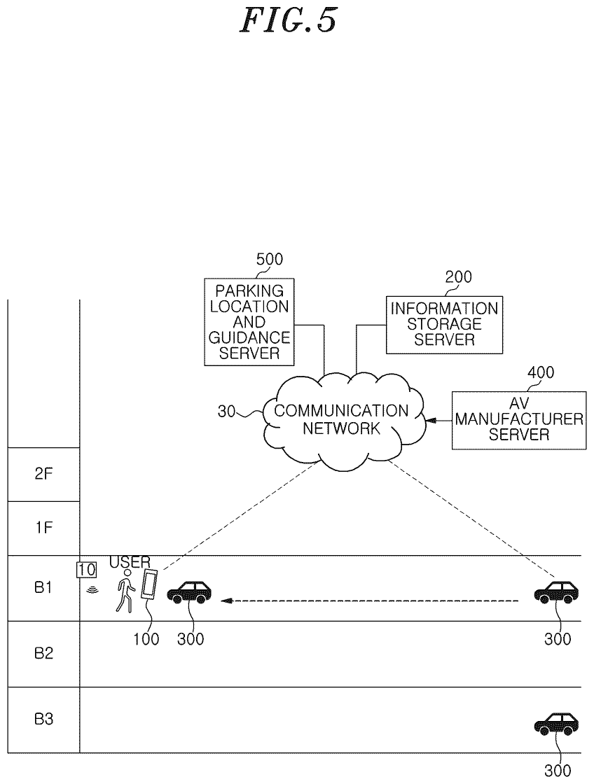

FIG. 5 is a diagram for schematically describing execution of remote calling according to an embodiment of the present disclosure. FIG. 5 is a diagram for allowing the detailed control operation of a first operation mode described with reference to FIG. 4A to be more easily understood.

Referring to FIG. 5, a user USER and the mobile device 100 may be located, for example, at a wireless signal generator 10 installed near a common entrance in a basement first floor B1. In this case, when the location transform application 164 is executed in the background, the mobile device 100 enters the first operation mode of receiving mapping information corresponding to the unique ID of the wireless signal generator 10 and providing the TGPS location information. When the user executes the AV control application 162 for the remote calling through the mobile device 100, the user's current location, i.e., the generated TGPS location information, becomes destination information for the remote calling. Accordingly, the autonomous driving vehicle 300 parked in a parking zone of the basement first floor B1 autonomously moves and arrives at the location where the user is present with support of the information storage server 200, the AV manufacturer server 400, and the parking location and guidance server 500 connected to the communication network 30.

Meanwhile, it should be understood that, even when the mobile device 100 and the autonomous driving vehicle 300 are located on different floors, the TGPS location information for the remote calling may be provided according to user selection. For example, when the autonomous driving vehicle 300 parked on a basement third floor B3 is an autonomous driving vehicle capable of recognizing destination floor-level information and moving to the generated TGPS location information on the basement first floor based on stored steering angle information and camera information, the user may execute the remote calling.

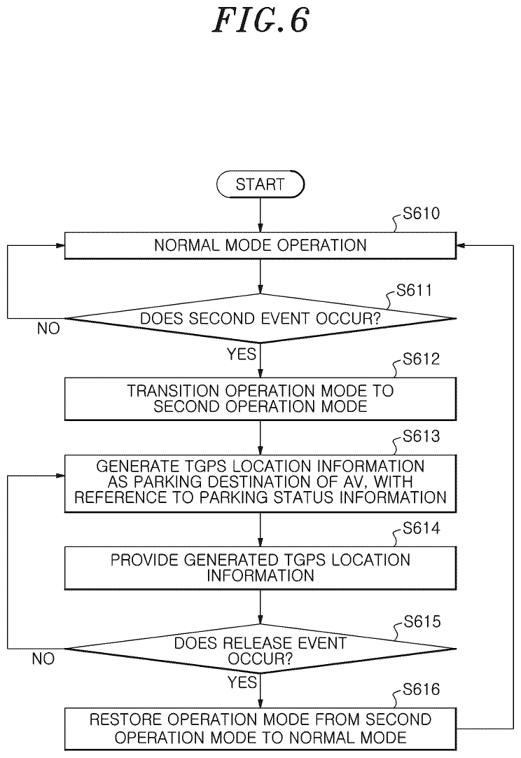

FIG. 6 is a flowchart illustrating an autonomous-parking support operation in a mobile device, according to an embodiment of the present disclosure.

Referring to FIG. 6, autonomous parking refers to an operation in which a user gets off the autonomous driving vehicle 300, and the autonomous driving vehicle 300 moves by itself to a parking destination, for example, an empty parking space in an underground parking lot or an empty parking space in a designated parking zone, and then parks. Accordingly, autonomous parking is conceptually similar to valet parking, but differs from valet parking in that the vehicle parks by itself in an unmanned state.

Referring to FIGS. 6, 1, and 2 together, in operation S610, the control module 127 of the mobile device 100 may perform a normal mode operation. Since operation S610 is the same as the above-described operation S310, an additional description will be omitted to avoid redundancy.

Similar to the remote calling, in the case of the autonomous parking, the location transform application 164 may be executed as a background application of the mobile device 100. When the autonomous driving vehicle 300 is stopped in an underground parking lot, which may be a GPS shadow area, the user may generate the autonomous parking (or a reverse summon) using the mobile device 100. When the autonomous parking is generated, execution of the AV control application 162 of the mobile device 100 is started.

In operation S611, the control module 127 of the mobile device 100 may determine whether a second event occurs. The second event may occur when the mobile device 100 carried by a user of the autonomous driving vehicle 300 receives a wireless signal in a specific area of the underground parking lot for the autonomous parking.

For example, when the mobile device 100 is located in a reception shadow area in which the GPS reception module 110 is unable to normally receive the GPS location information, the second event may occur when a wireless signal for performing the autonomous parking is received from at least one wireless signal generator 10 installed in the reception shadow area.

In addition, the second event may occur when QR code information for performing the autonomous parking is obtained from at least one code information storage unit 20 installed in the reception shadow area.

In addition, the second event may occur when, in the reception shadow area, the user of the mobile device 100 directly inputs destination location information of the autonomous parking, or when the user selects the destination location information of the autonomous parking from a parking-lot coordinate table for performing the autonomous parking through a display screen of the mobile device 100.

In addition, when the user of the mobile device 100 performs fingerprint recognition or facial recognition at a common entrance lobby phone installed in the reception shadow area and an entry signal for the second event mapped in correspondence to the fingerprint recognition or facial recognition of the user is received from a home network server communicating with the common entrance lobby phone, the second event may occur.

In addition, the second event may occur when the user of the mobile device 100 directly provides a setting input for the second event through the mobile device 100.

When the second event occurs in operation S611, in operation S612, the control module 127 of the mobile device 100 may transition an operation mode to a second operation mode. That is, the control module 127 of the mobile device 100 may change the operation mode from the normal mode operation to the second operation mode. In this case, the control module 127 of the mobile device 100 may output the switching control signal SCS having a low-level. Accordingly, the switch SW of the switching unit 130 is connected to the switching node S2 so that, when the TGPS location information is generated from the TGPS generation module 129, the TGPS location information may be provided to the AV control module 151.

Meanwhile, the change from the normal mode operation to the second operation mode may also be performed based on an autonomous-parking access waiting order so as to prevent or reduce congestion or blockage in the underground parking lot.

In operation S613, the control module 127 of the mobile device 100 may control, with reference to parking status information, the TGPS location information corresponding to an empty parking space to be generated as a parking destination of the autonomous driving vehicle 300.

The TGPS location information to be generated for the autonomous parking may be generated when the TGPS location information is directly provided to the user input reception module 123. In addition, the TGPS location information to be generated for the autonomous parking may be generated based on empty-parking-space information by user selection or designation.

Destination information of the autonomous parking refers to a geographic point at which the autonomous driving vehicle 300 will be parked in response to an autonomous-parking command, and may indicate geographic location information of an empty parking space.

In operation S614, the control module 127 of the mobile device 100 may provide the TGPS location information provided from the TGPS generation module 129 to the switching unit 130. The switching unit 130 may allow the TGPS location information to be applied to the AV control module 151. Accordingly, the AV control module 151 may receive the TGPS location information as destination information of the autonomous parking. When the AV control module 151 receives the TGPS location information, the AV driving application 310 of the autonomous driving vehicle 300 may control the autonomous parking based on the TGPS location information. By the autonomous parking, the autonomous driving vehicle 300 may move to a coordinate point in the underground parking lot indicated by the TGPS location information, which is the destination information of the autonomous parking.

Ultimately, by execution of the location transform application 164, the TGPS location information for autonomous parking may be provided through the transform GPS (TGPS) generation module 129, and thus the autonomous parking for the autonomous driving vehicle 300 may be smoothly supported even in the underground parking lot.

In operation S615, the control module 127 of the mobile device 100 may determine whether a release event for the second event occurs.

The release event for the second event may occur when the autonomous driving vehicle 300 reaches the destination of the autonomous parking.

In addition, the release event for the second event may occur when the user of the mobile device 100 directly provides a release input for the second event through the mobile device 100.

In addition, the release event for the second event may occur when parking location information related to the autonomous driving vehicle 300 is received from the parking location and guidance server 500 that performs vehicle number recognition through cameras and controls parking location and parking guidance in the underground parking lot.

When the release event for the second event occurs in operation S615, in operation S616, the control module 127 of the mobile device 100 may allow the operation mode of the mobile device 100 to be returned from the second operation mode to the normal mode.

In this case, the control module 127 of the mobile device 100 may apply the switching control signal SCS having a high-level to the switching unit 130. Accordingly, the switch SW of the switching unit 130 returns and is connected to the switching node S1, so that the GPS location information received through the GPS reception module 110 may be provided to the AV control module 151. Accordingly, the AV driving application 310 of the autonomous driving vehicle 300 may operate based on the GPS location information.

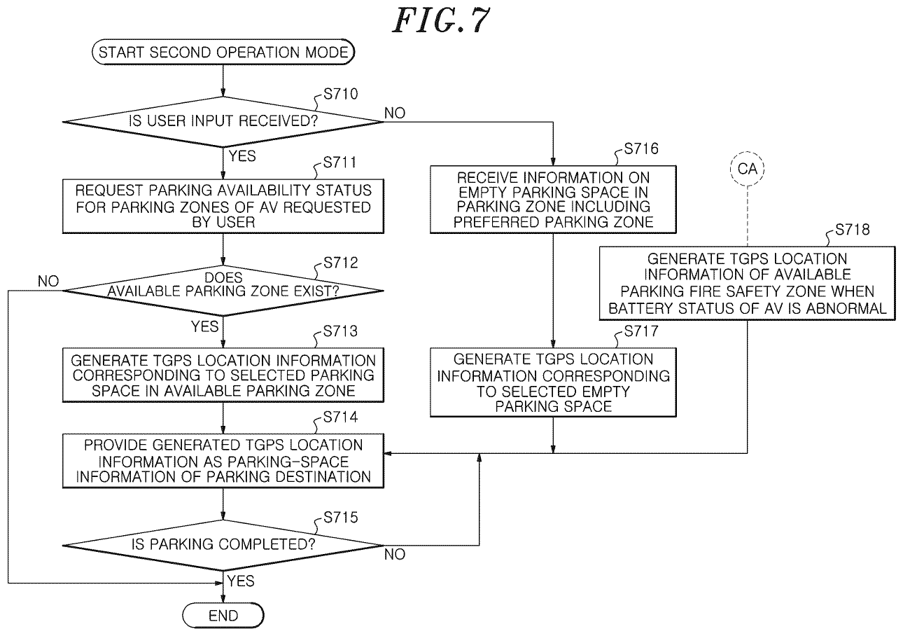

FIG. 7 is a block diagram illustrating a detailed control operation of a second operation mode of FIG. 6.

Referring to FIG. 7, the control module 127 of the mobile device 100 may start an operation in the second operation mode.

In operation S710, the control module 127 of the mobile device 100 may determine whether a user input is received. When the user input is received by the user input reception module 123 of FIG. 2, the control module 127 of the mobile device 100 may determine that the user input is received.

When the user input is received in operation S710, in operation S711, the control module 127 of the mobile device 100 may request, from the parking location and guidance server 500, a parking availability status for parking zones of the autonomous driving vehicle 300 requested by the user. Accordingly, the parking location and guidance server 500 may provide an available parking zone in response to the request for the parking availability status.

When an available parking zone exists in operation S712, in operation S713, the control module 127 of the mobile device 100 may generate, through the transform GPS (TGPS) generation module 129, transform GPS location information corresponding to a selected parking space in the available parking zone. The information storage server 200 may store the TGPS location information mapped in correspondence to parking spaces in the available parking zone. Ultimately, each empty parking space may be mapped with corresponding TGPS location information.

In operation S714, the control module 127 of the mobile device 100 provides the generated TGPS location information as parking-space information of the parking destination.

When the user input is not received in operation S710, in operation S716, the control module 127 of the mobile device 100 may receive, from the parking location and guidance server 500, information on an empty parking space in a parking zone.

In operation S717, the control module 127 of the mobile device 100 may generate the transform GPS (TGPS) location information corresponding to the selected empty parking space.

Meanwhile, when a battery state of the autonomous driving vehicle 300 is abnormal, in operation S718, the control module 127 of the mobile device 100 may generate transform GPS location information of a fire safety zone stored in advance so as to prevent a fire. When a battery of the autonomous driving vehicle 300 is overheated or there is an explosion risk, the control module 127 of the mobile device 100 may receive a battery state message from the manufacturer server 400. In addition, when the abnormal battery state of the autonomous driving vehicle 300 is received from the autonomous driving vehicle 300 to the mobile device 100, the control module 127 of the mobile device 100 may receive the battery state message.

When operations S717 and S718 are completed, the above-described operation S714 may proceed.

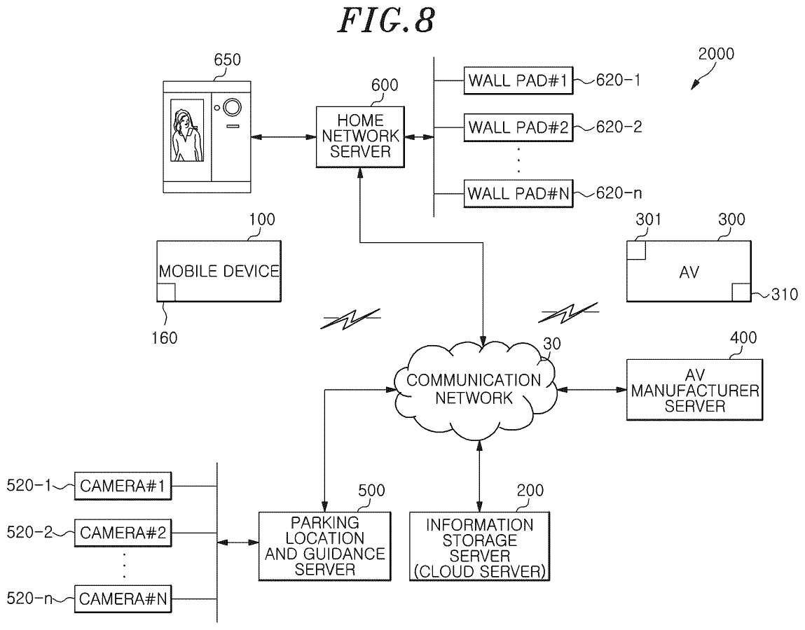

FIG. 8 is a block diagram illustrating a location transform system according to another embodiment of the present disclosure.

FIG. 8 illustrates the same or similar configuration as that of FIG. 1 except that FIG. 8 further includes a home network server 600, a plurality of wall pads 620-1, 620-2, . . . , 620-n, and a common entrance lobby phone 650. The common entrance lobby phone 650 may provide the same or similar function as the wireless signal generator 10 or the code information storage unit 20 of FIG. 1.

The plurality of wall pads 620-1, 620-2, . . . , 620-n may be installed correspondingly in households of a multi-family housing complex. For example, when the first wall pad 620-1 is installed in a living room of unit 101 in building 101, the second wall pad 620-2 may be installed in a living room of unit 102 in building 101. The plurality of wall pads 620-1, 620-2, . . . , 620-n may communicate and talk with the common entrance lobby phone 650 through the home network server 600.

In FIG. 8, a plurality of cameras 520-1, 520-2, . . . , 520-n may correspond to the camera device unit 520 of FIG. 1.

The plurality of cameras 520-1, 520-2, . . . , 520-n may be installed one by one correspondingly to a plurality of parking spaces in an underground parking lot to obtain images of vehicles and images of parking spaces. In addition, the plurality of cameras 520-1, 520-2, . . . , 520-n may provide a vehicle number recognition function for recognizing a vehicle number of the vehicles. The plurality of cameras 520-1, 520-2, . . . , 520-n may be assigned unique IDs related to their installation locations.

In more detail, the plurality of cameras 520-1, 520-2, . . . , 520-n may internally include an image sensor and a system-on-chip, and may be installed at positions capable of capturing images of parking spaces (e.g., six parking spaces or twelve parking spaces) within the parking lot. The image sensor may receive images of parking spaces partitioned in the parking lot through an omnidirectional camera lens and may capture the images. The omnidirectional camera lens may be implemented as a fisheye lens. The fisheye lens may be a lens that captures images of at least four or six or more parking spaces. In another embodiment, the fisheye lens may capture images of twelve parking spaces. The system-on-chip may capture and process images of the parking spaces captured by the image sensor to generate a full/empty/vehicle-present display control signal indicating a parking status on the parking spaces. The full/empty/vehicle-present display control signal may be generated by converting a parked original image into a grayscale image and binarizing the grayscale image to generate a binary image. That is, an image in a target region within the binary image may be used to determine whether a parking space is empty. By detecting edges in the target region in each of a current frame and a previous frame and comparing them with each other, whether a vehicle is parked in the parking space may be determined. Accordingly, a full/empty/vehicle-present display indicating whether the parking space is empty or occupied may be implemented.

In addition, the plurality of cameras 520-1, 520-2, . . . , 520-n may be installed correspondingly at each intersection or direction-changing path in which going straight, left/right turning, etc. are performed within the parking lot. Recognition of a vehicle number may be used to identify location information of the vehicle for parking guidance control.

The home network server 600 of FIG. 8 may communicate with the mobile device 100 through the communication network 30. The home network server 600 may store the TGPS location information mapped correspondingly to the common entrance lobby phone 650 for the remote calling. In the remote calling, the mapped TGPS location information becomes destination location information for the remote calling, and may indicate a geographic location near the common entrance lobby phone 650. When the user performs fingerprint recognition or facial recognition through the common entrance lobby phone 650, the home network server 600 may provide unique information corresponding to the user, such as a phone number, vehicle model information, vehicle number, and building/unit information of the multi-family housing complex.

In addition, even in the case of the autonomous parking, the user of the mobile device 100 may perform key or touch input, fingerprint recognition, or facial recognition through the common entrance lobby phone 650. In this case, the home network server 600 may provide, in correspondence to the user who performed the key or touch input, the fingerprint recognition, or the facial recognition, an entry signal for the second event and/or destination location information for the autonomous parking.

Although the home network server 600 is described as providing destination information in remote calling or autonomous parking operations, it should be understood that the present disclosure is not limited thereto and destination information mapped for remote calling or autonomous parking may be provided through the information storage server 200.

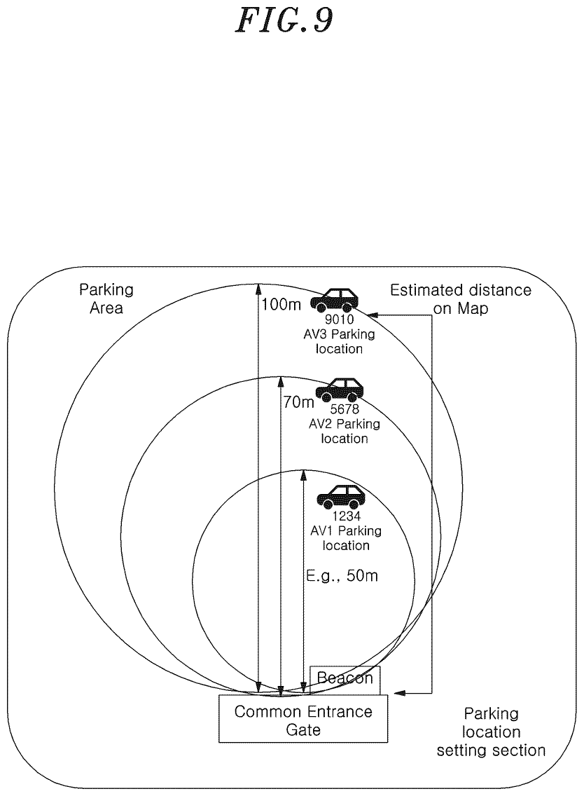

FIG. 9 is a diagram for describing an application range of a remote-calling support operation according to an embodiment of the present disclosure.

Referring to FIG. 9, distances from a gate of a common entrance in a parking zone of a parking lot to a parked vehicle are illustrated as 50m, 70m, and 100m, respectively. In the case of the remote calling, a callable distance may be limited to within 70m. However, it should be understood that the embodiment of the present disclosure is not limited thereto, and in special cases, the callable distance may be limited to within 50m or within 7m by setting in an application (or an app).

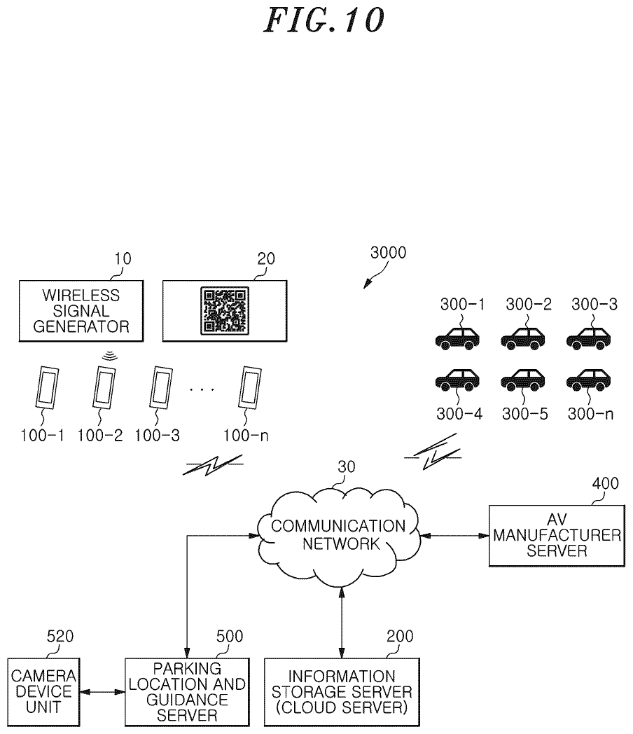

FIG. 10 is a block diagram illustrating a location transform system having a sequential waiting operation according to another embodiment of the present disclosure.

Referring to FIG. 10, a location transform system 3000 may further include a plurality of mobile devices 100-1, 100-2, 100-3, . . . , 100-n and a plurality of autonomous driving vehicles 300-1, 300-2, 300-3, . . . , 300-n as compared to the location transform system 1000 of FIG. 1.

For example, when the plurality of mobile devices 100-1, 100-2, 100-3, . . . , 100-n receive a wireless signal from the wireless signal generator 10 and substantially simultaneously perform the remote calling or the autonomous parking based on the TGPS location information, the plurality of autonomous driving vehicles 300-1, 300-2, 300-3, . . . , 300-n move at once, which may cause blockage or confusion in the underground parking lot.

Meanwhile, when the wireless signal generator 10 is a beacon, a plurality of BLE beacons may be installed in the underground parking lot. In this case, the mobile device 100-1 may receive a plurality of BLE signals from the plurality of BLE beacons. The mobile device 100-1 may determine, among the received BLE signals, the BLE signal having the strongest signal strength as an effective signal from which a unique ID may be obtained.

In the remote calling, when coordinate requests for installation locations of a BLE beacon, a UWB transmitter, a common entrance lobby phone, or a QR code are received from a plurality of mobile devices 100-1, 100-2, 100-3, . . . , 100-n within a set time, a waiting notification and sequential processing are required to resolve congestion of the autonomous driving vehicles 300-1, 300-2, 300-3, . . . , 300-n to be remotely called.

In addition, in the autonomous parking, when coordinate requests for destination location information are received from a plurality of mobile devices 100-1, 100-2, 100-3, . . . , 100-n within a set time, a waiting notification and sequential processing are also required to resolve congestion of the autonomous driving vehicles 300-1, 300-2, 300-3, . . . , 300-n to be autonomously parked.

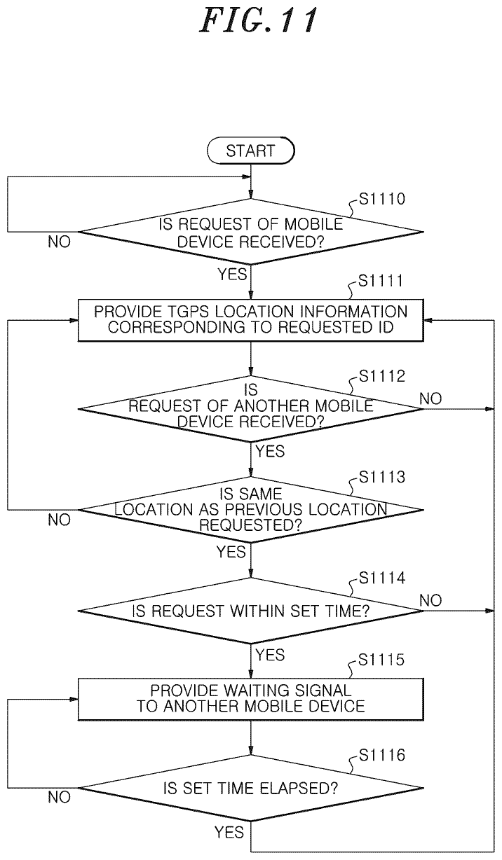

Accordingly, the information storage server 200 may perform a sequential waiting control operation as described below with reference to FIG. 11.

FIG. 11 is a flowchart illustrating a sequential waiting control operation in the information storage server 200 of FIG. 10.

Referring to FIG. 11, in operation S1110, the information storage server 200 determines whether a request is received from the mobile device 100-1.

When the request is received, in operation S1111, the information storage server 200 may read, from a stored mapping table, TGPS location information mapped in correspondence to the requested unique ID and may provide the TGPS location information to the mobile device 100-1.

In operation S1112, the information storage server 200 determines whether a request is received from another mobile device 100-2.

When the request is received from the another mobile device 100-2, in operation S1113, the information storage server 200 determines whether the requested unique ID is the same as a previously requested unique ID. That is, it is determined whether a destination location of previously requested remote calling and a destination location of currently requested remote calling are the same.

When requests related to the same location are received, in operation S1114, the information storage server 200 may determine whether the request is within a set time. For example, when the set time is set to 5 minutes, it may be determined whether the request from the other mobile device 100-2 is received after 5 minutes have elapsed since the request from the mobile device 100-1 was received. In addition, although not limiting the present disclosure, count information, obtained by counting how many vehicles have exited from the parking lot or how many vehicles have exited from parking spaces in a parking zone within the parking lot with reference to exit information of the autonomous driving vehicles 300-1, 300-2, 300-3, . . . , 300-n or exit information in the parking zone, may be additionally reflected in the waiting control operation in the remote calling.

When the current request is a request received within the set time, in operation S1115, the information storage server 200 may provide a waiting signal to the another mobile device 100-2. Accordingly, a user of the other mobile device 100-2 may recognize that the user of the mobile device 100-1 performs the remote calling first and may wait.

In operation S1116, the information storage server 200 determines whether the set time elapses, and when the set time elapses, the operation may proceed to operation S1111.

In operation S1116, the information storage server 200 determines whether the set time elapses, and when the set time has not elapsed, the operation may proceed to operation S1115.

While the present specification may include many specific implementation details, the implementation details should not be construed as limitations on the scope of any claimed subject matter, but rather as descriptions of features specific to particular embodiments. Certain features described in the present specification in the context of separate embodiments may also be implemented in combination in a single embodiment. In contrast, various features described in the context of a single embodiment may also be implemented separately in multiple embodiments or in any suitable subcombination. Moreover, although features may be described above as acting in certain combinations and even initially claimed as such, one or more features from a claimed combination may in some cases be excluded from the combination, and the claimed combination may be directed to a subcombination or a variation of a subcombination.

Similarly, although operations are depicted in the drawings in a particular order, this should not be understood as requiring that such operations be performed in the particular order illustrated or in sequential order, or that all illustrated operations be performed to achieve desirable results. In certain circumstances, multitasking and parallel processing may be advantageous. Moreover, the separation of various system components in the embodiments described above should not be understood as requiring such separation in all embodiments, and the described program components and systems may generally be integrated together in a single software product or packaged into multiple software products.

Accordingly, specific embodiments of the subject matter of the present disclosure have been described herein. Other embodiments are within the scope of the following claims. In some cases, the actions recited in the claims may be performed in a different order and still achieve desirable results. In addition, the processes depicted in the accompanying drawings do not necessarily require the particular order illustrated or sequential order to achieve desirable results. In certain implementations, multitasking and parallel processing may be advantageous.

Although specific terms have been used herein, such terms are used only for the purpose of describing the present disclosure and are not intended to limit the meaning or to limit the scope of the present disclosure described in the claims. Therefore, those of ordinary skill in the art will understand that various modifications and equivalent other embodiments are possible therefrom. For example, in some cases, without departing from the technical spirit of the present disclosure, detailed control functions for communication methods or components used for the remote calling or the autonomous parking may be changed or modified.

What is claimed is:

1. A method for supporting remote calling to be performed by a mobile device, the method comprising:
receiving GPS location information provided from GPS satellites in a normal mode in which the GPS location information is being received;
when the GPS location information is not received or when a reception sensitivity of the GPS location information is weaker than a preset reference sensitivity such that location information different from the GPS location information is required, receiving input information including geographic information and detecting whether a first event occurs;
generating transform GPS (TGPS) location information to be used as substitute information for the GPS location information based on the input information obtained when an occurrence of the first event is detected; and
when the occurrence of the first event is detected, transitioning from the normal mode to a first operation mode for supporting the remote calling of an autonomous driving vehicle and allowing the transform GPS location information to be provided to the autonomous driving vehicle as destination location information for the remote calling.

2. The method of claim 1, wherein the first event occurs in response to at least one of:
when a wireless signal is received from at least one wireless signal generator installed in a reception shadow area in which it is difficult to normally receive the GPS location information;
when code information is obtained from at least one QR code installed in the reception shadow area;
when a user of the mobile device directly inputs the destination location information for the remote calling in the reception shadow area or selects the destination location information from a coordinate table of a parking lot through a screen of the mobile device;
when mapped destination location information corresponding to fingerprint recognition or facial recognition of the user is received from a home network server communicating with a common entrance lobby phone installed in the reception shadow area, in a case where the user performs the fingerprint recognition or the facial recognition at the common entrance lobby phone;
when, in response to a parking location confirmation request, mapped location information corresponding to a camera installed near a parking location of the autonomous driving vehicle and performing vehicle number recognition is received from a parking location and guidance server configured to perform the vehicle number recognition through cameras in the reception shadow area and to control parking location and parking guidance;
when mapped location information corresponding to the camera installed near a parking location of the autonomous driving vehicle and performing vehicle number recognition is received from the parking location and guidance server, which responds to vehicle information obtained by capturing the autonomous driving vehicle in a parked state;
when, while the vehicle information is obtained by capturing the autonomous driving vehicle in the parked state, the wireless signal is received from the wireless signal generator; and
when mapped location information corresponding to code information obtained by capturing the QR code installed near the parking location of the autonomous driving vehicle is received.

3. The method of claim 1, further comprising:
controlling an operation mode of the mobile device to return from the first operation mode to the normal mode when a release event of the first event occurs.

4. The method of claim 3, wherein the release event occurs in response to at least one of:
when a wireless signal generated from a wireless signal generator participating in occurrence of the first event is not received or has a signal strength weaker than a preset sensitivity;
when the mobile device is paired with a Bluetooth device installed in the autonomous driving vehicle;
when a beacon signal is received from a mode-release BLE beacon additionally installed in the autonomous driving vehicle;
when a preset time related to the first event elapses;
when, in a case where the autonomous driving vehicle exits from an underground parking lot to an outside, a beacon signal is received from a GPS return beacon installed at an exit of the underground parking lot;
when a user of the mobile device directly provides a release input of the first event through the mobile device; and
when parking location information is not confirmed or exit information recognized through a camera is received from a parking location and guidance server configured to perform vehicle number recognition through cameras in the underground parking lot and to control parking location and parking guidance.

5. The method of claim 1, wherein in the first operation mode, the method further comprises:
receiving, from the input information obtained when occurrence of the first event is detected, floor-level information of a parking lot in which the mobile device is located;
when communication with a parking location and guidance server is possible, receiving, within the same parking lot, floor-level information in which the autonomous driving vehicle is parked;
when the floor-level information of the mobile device matches the floor-level information of the autonomous driving vehicle and is within a preset distance, notifying a user of the mobile device that the remote calling is available;
when the floor-level information of the mobile device differs from the floor-level information of the autonomous driving vehicle, notifying the user that the autonomous driving vehicle is located on a different floor;
when the floor-level information of the autonomous driving vehicle is not received, notifying the user that the autonomous driving vehicle may exist on either the same floor or a different floor; and
controlling the transform GPS location information to be provided as the destination location information for the remote calling.

6. The method of claim 2, wherein the wireless signal generator includes at least one of a BLE beacon, a Wi-Fi device, and a UWB transmitter; and
wherein installation location information of the BLE beacon, the Wi-Fi device, or the UWB transmitter and installation location information of the QR code are mapped, in a coordinate form including latitude and longitude, into an information storage server wirelessly communicating with a communication module of the mobile device.

7. The method of claim 6, wherein the information storage server is a cloud server; and
when coordinate requests for installation locations of the BLE beacon, the Wi-Fi device, the UWB transmitter, the common entrance lobby phone, or the QR code are received from a plurality of mobile devices within a preset time, the information storage server performs waiting notification and sequential processing to relieve congestion of autonomous driving vehicles to be remotely called.

8. The method of claim 1, wherein, in the controlling, an autonomous driving vehicle control application interoperating with a full self-driving application of the autonomous driving vehicle is used.

9. A non-transitory computer-readable storage medium storing computer-executable instructions, the computer executable instructions, when executed by a processor, cause the processor to perform a method, the method comprising:
receiving GPS location information provided from GPS satellites in a normal mode in which the GPS location information is being received;
when the GPS location information is not received or when a reception sensitivity of the GPS location information is weaker than a preset reference sensitivity such that location information different from the GPS location information is required, receiving input information including geographic information and detecting whether a first event occurs;
generating transform GPS (TGPS) location information to be used as substitute information for the GPS location information based on the input information obtained when an occurrence of the first event is detected; and
when the occurrence of the first event is detected, transitioning from the normal mode to a first operation mode for supporting the remote calling of an autonomous driving vehicle and allowing the transform GPS location information to be provided to the autonomous driving vehicle as destination location information for the remote calling.

10. The non-transitory computer-readable storage medium of claim 9, wherein the first event occurs in response to at least one of:
when a wireless signal is received from at least one wireless signal generator installed in a reception shadow area in which it is difficult to normally receive the GPS location information;
when code information is obtained from at least one QR code installed in the reception shadow area;
when a user of the mobile device directly inputs the destination location information for the remote calling in the reception shadow area or selects the destination location information from a coordinate table of a parking lot through a screen of the mobile device;
when mapped destination location information corresponding to fingerprint recognition or facial recognition of the user is received from a home network server communicating with a common entrance lobby phone installed in the reception shadow area, in a case where the user performs the fingerprint recognition or the facial recognition at the common entrance lobby phone;
when, in response to a parking location confirmation request, mapped location information corresponding to a camera installed near a parking location of the autonomous driving vehicle and performing vehicle number recognition is received from a parking location and guidance server configured to perform the vehicle number recognition through cameras in the reception shadow area and to control parking location and parking guidance;
when mapped location information corresponding to the camera installed near a parking location of the autonomous driving vehicle and performing vehicle number recognition is received from the parking location and guidance server, which responds to vehicle information obtained by capturing the autonomous driving vehicle in a parked state;
when, while the vehicle information is obtained by capturing the autonomous driving vehicle in the parked state, the wireless signal is received from the wireless signal generator; and
when mapped location information corresponding to code information obtained by capturing the QR code installed near the parking location of the autonomous driving vehicle is received.

11. The non-transitory computer-readable storage medium of claim 9, the method further comprising:
controlling an operation mode of the mobile device to return from the first operation mode to the normal mode when a release event of the first event occurs.

12. The non-transitory computer-readable storage medium of claim 11, wherein the release event occurs in response to at least one of:
when a wireless signal generated from a wireless signal generator participating in occurrence of the first event is not received or has a signal strength weaker than a preset sensitivity;
when the mobile device is paired with a Bluetooth device installed in the autonomous driving vehicle;
when a beacon signal is received from a mode-release BLE beacon additionally installed in the autonomous driving vehicle;
when a preset time related to the first event elapses;
when, in a case where the autonomous driving vehicle exits from an underground parking lot to an outside, a beacon signal is received from a GPS return beacon installed at an exit of the underground parking lot;
when a user of the mobile device directly provides a release input of the first event through the mobile device; and
when parking location information is not confirmed or exit information recognized through a camera is received from a parking location and guidance server configured to perform vehicle number recognition through cameras in the underground parking lot and to control parking location and parking guidance.

13. The non-transitory computer-readable storage medium of claim 9, wherein in the first operation mode, the method further comprises:
receiving, from the input information obtained when occurrence of the first event is detected, floor-level information of a parking lot in which the mobile device is located;
when communication with a parking location and guidance server is possible, receiving, within the same parking lot, floor-level information in which the autonomous driving vehicle is parked;
when the floor-level information of the mobile device matches the floor-level information of the autonomous driving vehicle and is within a preset distance, notifying a user of the mobile device that the remote calling is available;
when the floor-level information of the mobile device differs from the floor-level information of the autonomous driving vehicle, notifying the user that the autonomous driving vehicle is located on a different floor;
when the floor-level information of the autonomous driving vehicle is not received, notifying the user that the autonomous driving vehicle may exist on either the same floor or a different floor; and
controlling the transform GPS location information to be provided as the destination location information for the remote calling.

14. The non-transitory computer-readable storage medium of claim 10, wherein the wireless signal generator includes at least one of a BLE beacon, a Wi-Fi device, and a UWB transmitter; and
wherein installation location information of the BLE beacon, the Wi-Fi device, or the UWB transmitter and installation location information of the QR code are mapped, in a coordinate form including latitude and longitude, into an information storage server wirelessly communicating with a communication module of the mobile device.

15. The non-transitory computer-readable storage medium of claim 13, wherein the information storage server is a cloud server; and
when coordinate requests for installation locations of the BLE beacon, the Wi-Fi device, the UWB transmitter, the common entrance lobby phone, or the QR code are received from a plurality of mobile devices within a preset time, the information storage server performs waiting notification and sequential processing to relieve congestion of autonomous driving vehicles to be remotely called.

16. The non-transitory computer-readable storage medium of claim 9, wherein, in the controlling, an autonomous driving vehicle control application interoperating with a full self-driving application of the autonomous driving vehicle is used.

17. A mobile device comprising:
a memory storing at least one instruction; and
a processor,
wherein the at least one instruction, when executed by the processor, causes the processor to:
receive GPS location information provided from GPS satellites in a normal mode in which the GPS location information is being received;
when the GPS location information is not received or when a reception sensitivity of the GPS location information is weaker than a preset reference sensitivity such that location information different from the GPS location information is required, receive input information including geographic information and detect whether a first event occurs;
generate transform GPS (TGPS) location information to be used as substitute information for the GPS location information based on the input information obtained when an occurrence of the first event is detected; and
when the occurrence of the first event is detected, transition from the normal mode to a first operation mode for supporting the remote calling of an autonomous driving vehicle and allow the transform GPS location information to be provided to the autonomous driving vehicle as destination location information for the remote calling.

18. The mobile device of claim 17, wherein the first event occurs in response to at least one of:
when a wireless signal is received from at least one wireless signal generator installed in a reception shadow area in which it is difficult to normally receive the GPS location information;
when code information is obtained from at least one QR code installed in the reception shadow area;
when a user of the mobile device directly inputs the destination location information for the remote calling in the reception shadow area or selects the destination location information from a coordinate table of a parking lot through a screen of the mobile device;
when mapped destination location information corresponding to fingerprint recognition or facial recognition of the user is received from a home network server communicating with a common entrance lobby phone installed in the reception shadow area, in a case where the user performs the fingerprint recognition or the facial recognition at the common entrance lobby phone;
when, in response to a parking location confirmation request, mapped location information corresponding to a camera installed near a parking location of the autonomous driving vehicle and performing vehicle number recognition is received from a parking location and guidance server configured to perform the vehicle number recognition through cameras in the reception shadow area and to control parking location and parking guidance;
when mapped location information corresponding to the camera installed near a parking location of the autonomous driving vehicle and performing vehicle number recognition is received from the parking location and guidance server, which responds to vehicle information obtained by capturing the autonomous driving vehicle in a parked state;
when, while the vehicle information is obtained by capturing the autonomous driving vehicle in the parked state, the wireless signal is received from the wireless signal generator; and
when mapped location information corresponding to code information obtained by capturing the QR code installed near the parking location of the autonomous driving vehicle is received.

19. The mobile device of claim 17, wherein the processor controls an operation mode of the mobile device to return from the first operation mode to the normal mode when a release event of the first event occurs.

20. The mobile device of claim 17, wherein the release event occurs in response to at least one of:
when a wireless signal generated from a wireless signal generator participating in occurrence of the first event is not received or has a signal strength weaker than a preset sensitivity;
when the mobile device is paired with a Bluetooth device installed in the autonomous driving vehicle;
when a beacon signal is received from a mode-release BLE beacon additionally installed in the autonomous driving vehicle;
when a preset time related to the first event elapses;
when, in a case where the autonomous driving vehicle exits from an underground parking lot to an outside, a beacon signal is received from a GPS return beacon installed at an exit of the underground parking lot;
when a user of the mobile device directly provides a release input of the first event through the mobile device; and
when parking location information is not confirmed or exit information recognized through a camera is received from a parking location and guidance server configured to perform vehicle number recognition through cameras in the underground parking lot and to control parking location and parking guidance.
